(19) United States
(12) Patent Application Publication
(10) Pub. No.: US 2026/0027790 A1
(43) Pub. Date: Jan. 29, 2026

(54) METHODS OF MANUFACTURING A HYBRID METAL/COMPOSITE BATTERY TRAY

(71) Applicant: GM GLOBAL TECHNOLOGY OPERATIONS LLC, Detroit, MI (US)

(72) Inventors: Venkateshwar R. Aitharaju, Troy, MI (US); Xiaosong Huang, Novi, MI (US); Selina X. Zhao, Rochester Hills, MI (US); Bradley A. Newcomb, Troy, MI (US); Bhavesh Shah, Troy, MI (US); Alexander Millerman, Bloomfield Township, MI (US)

(73) Assignee: GM GLOBAL TECHNOLOGY OPERATIONS LLC, Detroit, MI (US)

(21) Appl. No.: 18/787,213

(22) Filed: Jul. 29, 2024

(51) Int. Cl. B29C 70/84; B29C 65/00; B29C 70/48; B29C 70/68; B29L 31/00

(52) U.S. Cl. CPC B29C 70/845; B29C 66/1122; B29C 66/721; B29C 66/742; B29C 70/48; B29C 70/682; B29L 2031/7146

(57) ABSTRACT

The present disclosure teaches methods of manufacturing hybrid metal/composite battery trays. The hybrid trays, which may be deep, may be made of a metallic (e.g., steel or aluminum alloy), cruciform-shaped partial tray with four, polymer/fiber composite rounded corner inserts that are attached to recessed corners of the partial tray. Overlapping bond joints may be co-molded. Overlapping metallic bond surfaces may be pre-treated by laser ablation and/or by plasma exposure, to increase the bond strength between overlapping metal and polymer/fiber composite surfaces. Mechanical interlocking features may be used to increase joint strength. Hybrid metal/composite trays may be fabricated by press-forming dissimilar parts using a molding tool and a press. Resin Transfer Molding (RTM) with thermoset resin may be used for co-molding four, fibrous preform corner inserts to the cruciform-shaped partial tray. Alternatively, press-forming and curing may be used for attaching thermoplastic polymer/fiber composite prepreg corner inserts to the cruciform-shaped partial tray.

### INTRODUCTION

This disclosure relates to methods of manufacturing hybrid metal/composite battery trays for use with all-electric or hybrid-electric automotive vehicles.

Metal battery trays are configured for securely holding arrays of batteries for use in all-electric or hybrid-electric vehicles, and other applications. These trays are typically made of steel sheet metal parts (e.g., press-formed panels, stamped sheets, etc.) that are welded together to form an integrated structure. Manufacturing these metal battery trays typically requires fabricating multiple, thin panels with complex shapes that are joined together using complex tooling and large numbers of welds. Additionally, openings and joints in the tray require sealing with a sealant material (e.g., putty) to make them leak-tight, which may incur high manual labor costs. The use of polymer-based fiber reinforced composite materials, combined with a press-formed sheet metal partial tray, may allow for deeper trays to be fabricated, with lower weight and lower cost, while retaining the necessary structural strength and design flexibility.

### SUMMARY

The present disclosure teaches methods of manufacturing hybrid metal/composite battery trays. The hybrid trays, which may be deep, may be made of a metallic (e.g., steel or aluminum alloy), cruciform-shaped partial tray with four, polymer/fiber composite rounded corner inserts that are attached to recessed corners of the partial tray. Overlapping bond joints may be co-molded. Overlapping metallic bond surfaces may be pre-treated by laser ablation and/or by plasma exposure, to increase the bond strength between overlapping metal and polymer/fiber composite surfaces. Mechanical interlocking features may be used to increase joint strength. Hybrid metal/composite trays may be fabricated by press-forming dissimilar parts using a molding tool and a press. Resin Transfer Molding (RTM) with thermoset resin may be used for co-molding four, fibrous preform corner inserts to the cruciform-shaped partial tray. Alternatively, press-forming and curing may be used for attaching thermoplastic polymer/fiber composite prepreg corner inserts to the cruciform-shaped partial tray.

In a first embodiment, a method of manufacturing a hybrid tray, includes: (1) providing a partial tray, made of a first material, having a cruciform shape and four recessed corners, (2) providing four, rounded corner inserts, made of a second material, and then (3) attaching each rounded corner insert to each corresponding recessed corner of the partial tray, thereby making a hybrid tray with four attached rounded corners.

In a second embodiment, the first material is a metal, a steel alloy, a magnesium alloy, a titanium alloy, or an aluminum alloy, and/or a combination thereof.

In a third embodiment, the second material is a polymeric material, a polymer/fiber composite material, a thermoplastic polymer/fiber composite material, or a thermoset polymer/fiber composite material, and/or a combination thereof. The second material may further comprise glass fibers, carbon fibers, graphite fibers, metal fibers, ceramic fibers, polymer fibers, or natural fibers, and/or combinations thereof.

In a fourth embodiment, attaching each rounded corner insert to each corresponding recessed corner of the partial tray includes: (4) providing four overlapping first bond surfaces of each respective one of the four rounded corner inserts, (5) providing four overlapping second bond surfaces at each respective one of the four recessed corners of the partial tray, (6) aligning and overlapping each respective one of the four overlapping first bond surfaces with each respective one of the four overlapping second bond surfaces, and then (7) forming four overlapping bond joints by attaching each respective one of the four overlapping first bond surfaces to each respective one of the four overlapping second bond surfaces.

In a fifth embodiment, the manufacturing method further includes fabricating one or more mechanical interlocking features (e.g., a series of multiple, interlocking recessed dimples and/or interlocking bumps), at each overlapping bond joint, thereby improving bond shear strength.

In a sixth embodiment, the manufacturing method includes placing a non-conductive interlayer between each overlapping first and second bond surfaces of each one of the four rounded corner inserts and each recessed corner of the partial tray, respectively, to reduce galvanic corrosion when conductive carbon, graphite, and/or metallic fibers are used in a polymer/fiber composite material. The non-conductive interlayer may include glass fibers.

In a seventh embodiment, the manufacturing method includes placing a removable gasket in-between an upper molding tool and a lower molding tool, and then using the removable gasket to control and reduce excessive flow of liquid resin when a resin transfer molding process (i.e., co-molding) is used to attach each respective one of the four rounded corner inserts to the partial tray.

In an eighth embodiment, the manufacturing method includes laser-ablating and/or plasma-treating each respective one of the four overlapping second bond surfaces of the partial tray, before attaching each respective one of the four rounded corner inserts to the partial tray.

In an ninth embodiment, a method of manufacturing a hybrid metal/composite tray includes: (a) cutting a rectangular metal sheet into a cruciform-shaped sheet, and then removing four cutout corners from the rectangular metal sheet, (b) cutting out four, fibrous preform corner inserts from one or more sheets of a fibrous material, (c) providing a press and a molding tool with four rounded corners, (d) draping each respective one of the four, fibrous preform corner inserts onto each respective one of the four rounded corners of the molding tool, (e) press-forming the four, fibrous preform corner inserts onto the four rounded corners of the molding tool to make four, rounded fibrous preform corner inserts, (f) placing the cruciform-shaped sheet onto the molding tool, thereby making an assembly comprising the cruciform-shaped sheet and the four, rounded fibrous preform corner inserts, and then (g) using a RTM process to inject thermoset resin around each respective one of the four, rounded fibrous preform corner inserts and the cruciform-shaped sheet, followed by (h) compressing and curing the assembly in the press.

In a tenth embodiment, a method of manufacturing a hybrid metal/composite tray includes: (a) making the partial tray by cutting a rectangular metal sheet into a cruciform-shaped sheet, and then removing four cutout corners from the rectangular metal sheet, (b) providing a press and a molding tool having four rounded corners, (c) press-forming the cruciform-shaped sheet into a preformed partial tray using the molding tool, (d) cutting out four, fibrous preform corner inserts from one or more sheets of a fibrous material, (e) draping each respective one of the four, fibrous preform corner inserts onto each respective one of the four rounded corners of the molding tool, (f) placing the preformed partial tray onto the molding tool, thereby making an assembly comprising the preformed partial tray and the four, fibrous preform corner inserts, and then (g) using a RTM process to inject thermoset resin around each respective one of the four, fibrous preform corner inserts and the preformed partial tray, followed by (h) compressing and curing the assembly in the press.

In a eleventh embodiment, a method of manufacturing a hybrid metal/composite tray includes: (a) cutting a rectangular metal sheet into a cruciform-shaped sheet, and then removing four cutout corners from the rectangular metal sheet, (b) providing a press and a molding tool having four rounded corners, (c) press-forming the cruciform-shaped sheet into a preformed partial tray using the molding tool, (d) cutting out four, fibrous preform corner inserts from one or more sheets of a fibrous material, (e) draping each respective one of the four, fibrous preform corner inserts onto each respective one of the four rounded corners of the molding tool, (f) press-forming the four, fibrous preform corner inserts on the molding tool, thereby making four rounded fibrous preform corner inserts, (g) placing the preformed partial tray onto the molding tool, thereby making an assembly comprising the four, fibrous preform corner inserts and the preformed partial tray, and then (h) using a RTM process to inject thermoset resin around each respective one of the four, rounded fibrous preform corner inserts and the preformed partial tray, and then (i) compressing and curing the assembly in the press.

In an twelfth embodiment, a method of manufacturing a hybrid metal/composite tray for use in a vehicle includes: (1) providing a partial tray, made of a metal, having a cruciform shape and four recessed corners, (2) providing four rounded corner inserts, made of a polymer/fiber composite material, and then (3) attaching each respective one of the four rounded corner inserts to each respective one of the four recessed corners of the partial tray, thereby making a hybrid metal/composite tray with four attached rounded corners. In this embodiment, the hybrid metal/composite tray is configured to be attached to the vehicle, and the hybrid tray is configured to hold one or more batteries.

In a thirteenth embodiment, a method of manufacturing a hybrid metal/composite tray includes: (a) cutting a rectangular metal sheet into a cruciform-shaped sheet, and then removing four cutout corners from the rectangular metal sheet, (b) cutting out four, thermoplastic polymer/fiber composite prepreg corner inserts from one or more sheets of a thermoplastic polymer/fiber composite prepreg material, (c) providing a press and a molding tool with four rounded corners, (d) placing each respective one of the four, thermoplastic polymer/fiber composite prepreg corner inserts onto each respective one of the four rounded corners of the molding tool, (e) press-forming the four, thermoplastic polymer/fiber composite prepreg corner inserts on the four rounded corners of the molding tool to make four, rounded thermoplastic polymer/fiber composite prepreg corner inserts, (f) placing the cruciform-shaped sheet onto the molding tool, thereby making an assembly comprising the cruciform-shaped sheet and the four, rounded thermoplastic polymer/fiber composite prepreg corner inserts, then (g) compressing the assembly using the press to make a compressed assembly and then (h) curing the compressed assembly at an elevated temperature.

In a fourteenth embodiment, a method of manufacturing a hybrid metal/composite tray includes: (a) cutting a rectangular metal sheet into a cruciform-shaped sheet, and then removing four cutout corners from the rectangular metal sheet, (b) providing a press and a molding tool having four rounded corners, (c) press-forming the cruciform-shaped sheet into a preformed partial tray using the molding tool, (d) cutting out four, thermoplastic polymer/fiber composite prepreg corner inserts from one or more sheets of a thermoplastic polymer/fiber composite prepreg material, (e) placing each respective one of the four, thermoplastic polymer/fiber composite prepreg corner inserts on each respective one of the four rounded corners of the molding tool, (f) placing the preformed partial tray onto the molding tool, thereby making an assembly comprising the preformed partial tray and the four, thermoplastic polymer/fiber composite prepreg corner inserts, then (g) compressing the assembly using the press to make a compressed assembly, and then (h) curing the compressed assembly at an elevated temperature.

In a fifteenth embodiment, a method of manufacturing a hybrid metal/composite tray includes: (a) cutting a rectangular metal sheet into a cruciform-shaped sheet, and then removing four cutout corners from the rectangular metal sheet, (b) providing a press and a molding tool having four rounded corners, (c) press-forming the cruciform-shaped sheet into a preformed partial tray using the molding tool, (d) cutting out four, thermoplastic polymer/fiber composite prepreg corner inserts from one or more sheets of a thermoplastic polymer/fiber composite prepreg material, (e) placing each respective one of the four, thermoplastic polymer/fiber composite prepreg corner inserts onto each respective one of the four rounded corners of the molding tool, (f) press-forming the four, thermoplastic polymer/fiber composite prepreg corner inserts on the molding tool, thereby making four, rounded thermoplastic polymer/fiber composite prepreg corner inserts, then (g) placing the preformed partial tray onto the molding tool, thereby making an assembly comprising the four, rounded thermoplastic polymer/fiber composite prepreg corner inserts and the preformed partial tray, then (h) compressing the assembly using the press to make a compressed assembly, and then (i) curing the compressed assembly at an elevated temperature.

In a sixteenth embodiment, the second material includes glass fibers, carbon fibers, graphite fibers, metal fibers, ceramic fibers, polymer fibers, or natural fibers, and/or combinations thereof.

In a seventeenth embodiment, the first material is a metal, a steel alloy, a magnesium alloy, a titanium alloy, or an aluminum alloy, and/or combinations thereof, and the second material is a polymeric material, a polymer/fiber composite material, a thermoplastic polymer/fiber composite material, or a thermoset polymer/fiber composite material, and/or combinations thereof.

In an eighteenth embodiment, the second material includes glass fibers, carbon fibers, graphite fibers, metal fibers, ceramic fibers, polymer fibers, or natural fibers, and/or combinations thereof.

In a nineteenth embodiment, a method of manufacturing a hybrid metal/composite tray includes: (1) cutting a rectangular metal sheet into a cruciform-shaped metal sheet, and then removing four cutout corners from the rectangular metal sheet to make a cruciform-shaped metal sheet with four recessed corners, (2) cutting out four, thermoplastic polymer/fiber composite prepreg corner inserts from one or more sheets of a thermoplastic polymer/fiber composite prepreg material, (3) providing a press and a molding tool with four rounded corners, (4) placing each respective one of the four, thermoplastic polymer/fiber composite prepreg corner inserts onto each respective one of the four rounded corners of the molding tool, (5) press-forming the four, thermoplastic polymer/fiber composite prepreg corner inserts on the molding tool to make four, rounded thermoplastic polymer/fiber composite prepreg corner inserts, (6) placing the cruciform-shaped metal sheet onto the molding tool, thereby making an assembly comprising the cruciform-shaped metal sheet and the four, rounded thermoplastic polymer/fiber composite prepreg corner inserts, then (7) compressing the assembly using the press to make a compressed assembly, and then (8) curing the compressed assembly at an elevated temperature, thereby making a hybrid metal/composite tray.

In a twentieth embodiment, the hybrid metal/composite tray is configured to be attached to a vehicle, and the hybrid metal/composite tray is configured to hold one or more batteries, and the cruciform-shaped metal sheet comprises a steel alloy or an aluminum alloy.

### BRIEF DESCRIPTION OF THE DRAWINGS

FIG. 1 shows a schematic perspective view of an example of an all-metal tray for holding batteries, made of multiple metal panels that are welded together, according to the present disclosure.

FIG. 2 shows a schematic perspective view of an example of a hybrid tray, according to the present disclosure.

FIG. 3A shows a schematic cross-section view (A-A) of an example of a hybrid tray, according to the present disclosure.

FIG. 3B shows a schematic, enlarged, cross-section view (A-A) of an example of an overlapping corner bond joint of a hybrid tray, according to the present disclosure.

FIG. 4 shows a schematic perspective view of an example of a hybrid tray, according to the present disclosure.

FIG. 5 shows a schematic cross-section view (B-B) of an example of an overlapped bond joint with a mechanical interlocking feature, according to the present disclosure.

FIG. 6 shows a schematic cross-section view (B-B) of an example of an overlapped bond joint with a non-conductive interlayer, according to the present disclosure.

FIG. 7 shows a schematic perspective view of an example of a hybrid tray, according to the present disclosure.

FIG. 8 shows a schematic cross-section view (C-C) of an example of an injection-molded bond joint with a removable gasket for controlling excess flow of injected resin, according to the present disclosure.

FIG. 9A shows a schematic plan view of an example of a rectangular metal sheet used to make a cruciform-shaped partial tray, according to the present disclosure.

FIG. 9B shows a schematic plan view of an example of a cruciform-shaped partial tray, according to the present disclosure.

FIG. 10 shows a schematic perspective view of an example of four rounded corner inserts, according to the present disclosure.

FIG. 11 shows a schematic perspective view of an example of a hybrid tray with four ports for doing resin transfer molding, according to the present disclosure.

FIG. 12 shows a schematic plan view of an example of a cruciform-shaped metallic partial tray with L-shaped, surface-treated corner stripes, according to the present disclosure.

FIG. 13 shows a schematic perspective view of an example of a press for press-forming a hybrid tray, according to the present disclosure.

FIG. 14A shows a schematic plan view of an example of a cruciform-shaped metal sheet prior to press-forming, according to the present disclosure.

FIG. 14B shows a schematic plan view of an example of a press-formed, cruciform-shaped partial tray after press-forming the cruciform-shaped sheet to form a partial tray with raised edges and top flanges, according to the present disclosure.

FIG. 15 shows an example of a process flow chart for manufacturing a hybrid tray, according to the present disclosure.

FIG. 16 shows an example of a process flow chart for manufacturing a hybrid tray, according to the present disclosure.

FIG. 17 shows an example of a process flow chart for manufacturing a hybrid tray, according to the present disclosure.

FIG. 18 shows an example of a process flow chart for manufacturing a hybrid tray, according to the present disclosure.

FIG. 19 shows an example of a process flow chart for manufacturing a hybrid tray, according to the present disclosure.

FIG. 20 shows an example of a process flow chart for manufacturing a hybrid tray, according to the present disclosure.

FIG. 21 shows an example of a process flow chart for manufacturing a hybrid tray, according to the present disclosure.

FIG. 22A shows a schematic elevation view of an example of a generic 3-point bending test configuration for testing a laminated sheet of one material bonded to a different material in in 3-point bending, according to the present disclosure.

FIG. 22B shows graphs of Force (kN) vs Displacement (mm) curves to failure for multiple, laminated, three-point bending samples of a steel sheet bonded (co-molded) to a polymer/fiber composite sheet, comparing bare (untreated) steel to laser-ablated steel, according to the present disclosure.

FIG. 23 shows an example of a process flow chart for manufacturing a hybrid tray, according to the present disclosure.

FIG. 24 shows an example of a process flow chart for manufacturing a hybrid tray, according to the present disclosure.

FIG. 25 shows an example of a process flow chart for manufacturing a hybrid tray, according to the present disclosure.

### DETAILED DESCRIPTION OF THE DISCLOSURE

The hybrid trays disclosed herein may be used in number of different mobile applications, including, but not limited to: automobiles, trucks, motorcycles, boats, submarines, airplanes, jets, spacecraft, trains or other mobile platforms, as well as stationary battery electric systems, such as power plants, appliances, and photovoltaic installations.

The term “hybrid tray” means a tray that may be made of two (or more) different materials that are joined together to make a tray with a continuous, single surface that is leak-tight. The term “different materials” is broadly defined also include two different metal alloys (including, for example, different steel alloys) that have different mechanical properties, such as different yield strength and/or different ductility. The term “deep tray” includes trays that are deeper than about 4 inches. The term “Swiss-Cross shape” is broadly defined as including both square and rectangular outlines of a cruciform-shaped partial tray. The words “attaching”, “joining”, and “bonding” are used interchangeably. The words “attached”, “joined”, and “bonded” are used interchangeably. The term “co-molding” means an operation where a polymer/fiber composite part and a metal part are manufactured and attached together into one, single component. An example of a “co-molding” operation may include combining a stamping process with an over-molding technique, such as resin transfer molding, or compression molding.

The word “prepreg” means that a fibrous piece of fabric and resin are mixed together in B-stage. Then, with elevated temperature during molding, the resin cures and forms the desired rigid geometry part. The word “preform” is both a noun and a verb that refers to a fibrous piece of fabric or a prepreg piece that is shaped to a desired geometry of the part that is being molded. The terms “fibrous material” and “fibrous fabric” mean a sheet, fabric, or block of fibers that are woven together in a defined, orderly pattern, or that are arranged as randomly-oriented fibers, or both. The word “fabric” means any cloth or flexible sheet made one or more types of fibers by weaving, knitting, felting, spinning, spray depositing, or other fabric fabrication techniques.

The words “a”, “an”, “the”, “at least one”, and “one or more” are used interchangeably to indicate that at least one of the items is present.

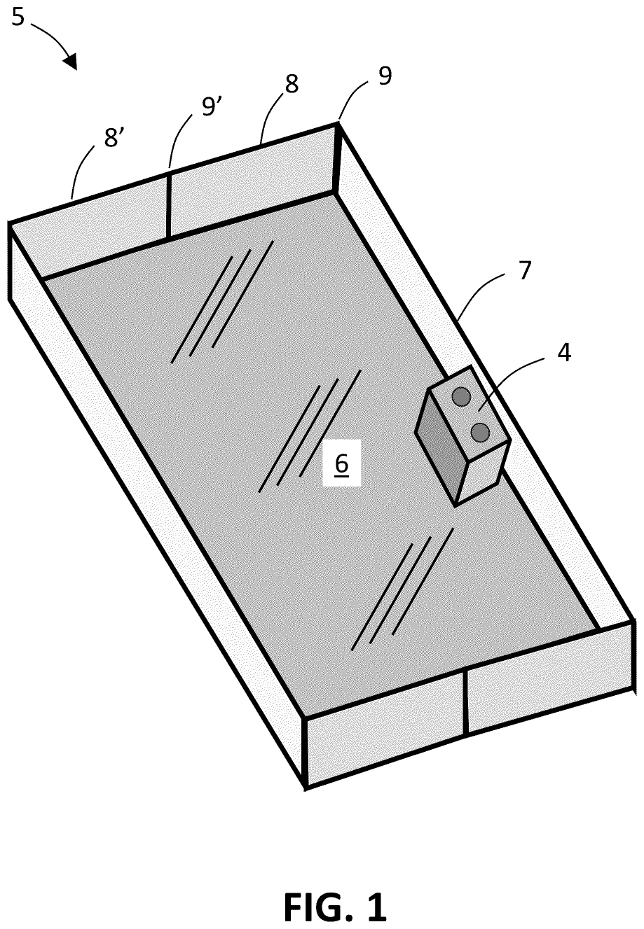

FIG. 1 shows a schematic perspective view of an example of a metallic, welded tray 5 for holding one or more batteries (e.g., battery 4), which is made of multiple panels of formed sheet metal (e.g., panels 6, 7, 8, and 8′) that are assembled and welded together with, for example, welded joints 9, 9′ according to the present disclosure. If metal tray 5 were to be constructed solely of metal, by press-forming and deep-drawing a single, large sheet of metal, then that tray's depth may be limited to less than about 4 inches (especially for high-strength metal alloys) because of excessive wrinkling and tearing of the thinned (stretched) sheet metal.

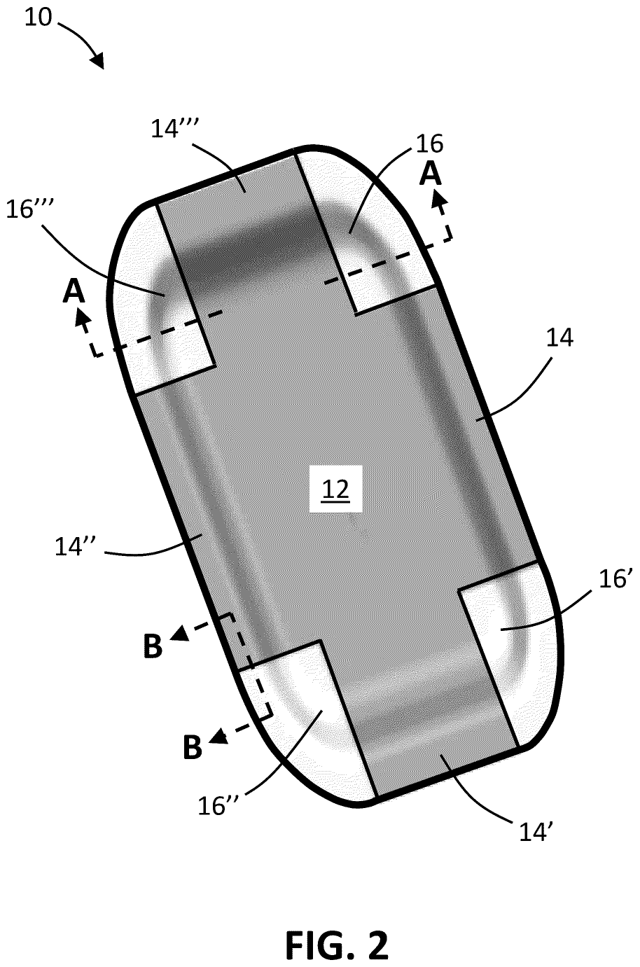

FIG. 2 shows a schematic perspective view of an example of a hybrid tray 10, according to the present disclosure. Tray 10 comprises a partial tray 12, made of a first material, and having four, rounded corner inserts 16, 16′, 16″, and 16′″, that are attached to partial tray 12. The four, rounded corner inserts 16, 16′, 16″, and 16′″ may be made of a second material. The second material may be different than the first material.

Referring still to FIG. 2, the first material may be a metallic material, including, for example: a metal, a steel alloy, a magnesium alloy, a titanium alloy, or an aluminum alloy, and/or combinations thereof. The second material may be a polymeric material without fiber-reinforcement (e.g., a plastic material), a polymer/fiber composite material, a thermoplastic polymer/fiber composite material, a thermoset polymer/fiber composite material, and/or combinations thereof. In some embodiments, partial tray 12 may be made of steel; and rounded corner inserts 16, 16′, 16″, and 16′″ may be made of a polymer/fiber composite material. The second material may also include: glass fibers, carbon fibers, graphite fibers, metal fibers, ceramic fibers, polymer fibers, or natural fibers, and/or combinations thereof. The fibers may be woven together in an orderly pattern, and/or randomly oriented in the composite material. A polymer/fiber composite material may comprise a polygonal-shaped piece of dry, fibrous fabric or polymer/fiber composite prepreg material.

Referring still to FIG. 2, hybrid tray 10 comprises four, raised edges (or raised lips) with four, top flanges 14, 14′, 14″, and 14′″. In some embodiments, the height (i.e., depth) of the top flanges 14, 14′, 14″, and 14′″ above a bottom surface 20 of tray 10 may be greater than about four inches.

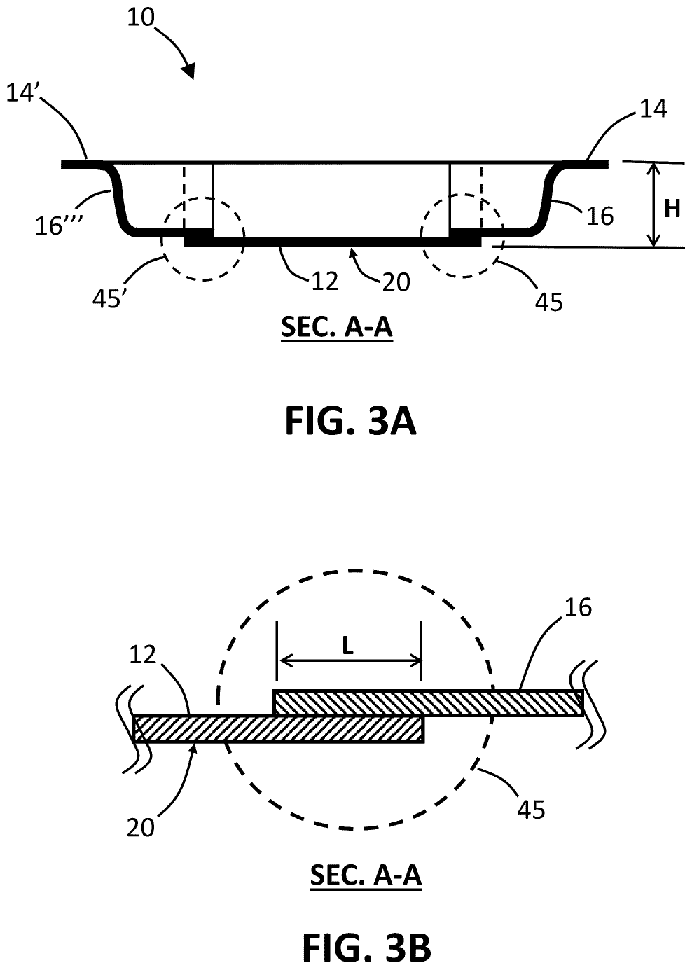

FIG. 3A shows a schematic cross-section view (A-A) of an example of a hybrid tray 10, according to the present disclosure. The height, H, of rounded corner inserts 16 and 16′ above the bottom surface 20 of partial tray 12 is defined. Height, H, may be less than about 6 inches. Alternatively, H may be greater than about 6 inches. Alternatively, H may be greater than about 7.5 inches. Overlapping bond joints 45 and 45′ are identified by the two, dashed circles.

FIG. 3B shows a schematic, enlarged, cross-section view (A-A) of an example of an overlapping corner bond joint 45 of a hybrid tray 10, according to the present disclosure. Overlapping corner bond joint 45 has an overlap bond length (width), L, between overlapping portions of rounded corner insert 16 and bottom surface 20 of partial tray 12. In this example, the bottom surface 20 of partial tray 12 is located below the two, rounded corner inserts 16 and 16′″. In another embodiment (not illustrated), the bottom surface 20 of partial tray 12 may be located above the two, rounded corner inserts 16 and 16′″.

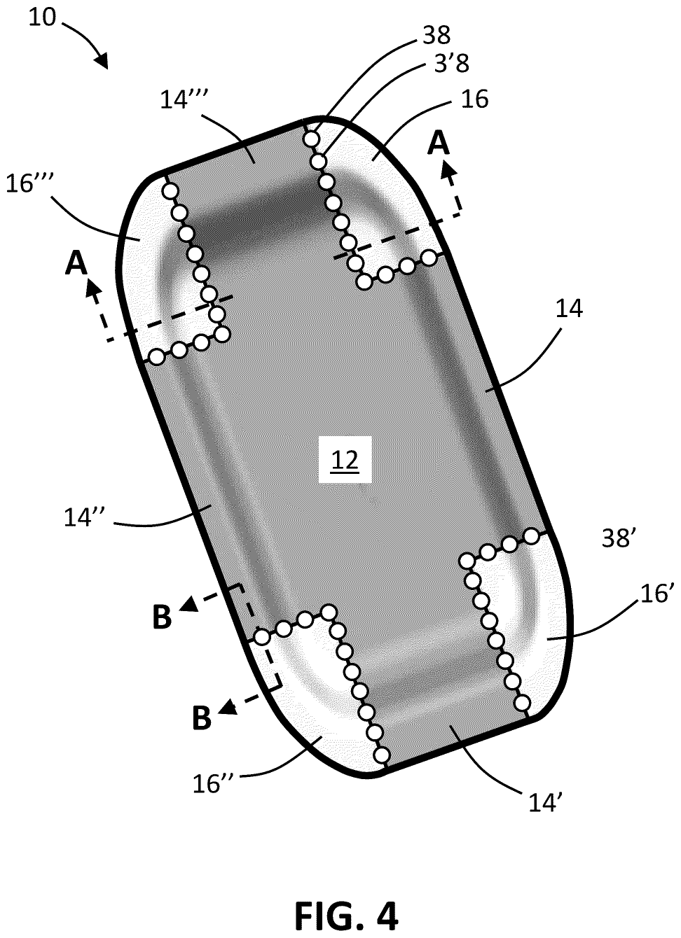

FIG. 4 shows a schematic perspective view of an example of a hybrid tray 10, according to the present disclosure. This example is similar to the example shown in FIG. 2, with the exception being that a plurality of mechanical interlocking features 38, 38′, etc. have been added to improve the bond shear and/or peeling strength between the four corner inserts 16, 16′, 16″, and 16′″ and the partial tray 12. Some examples of these mechanical interlocking features 38, 38′, etc. may include: semispherical depressions (i.e., dimples or bumps), pins, or rivets that increase the bond's shear and/or peeling strength.

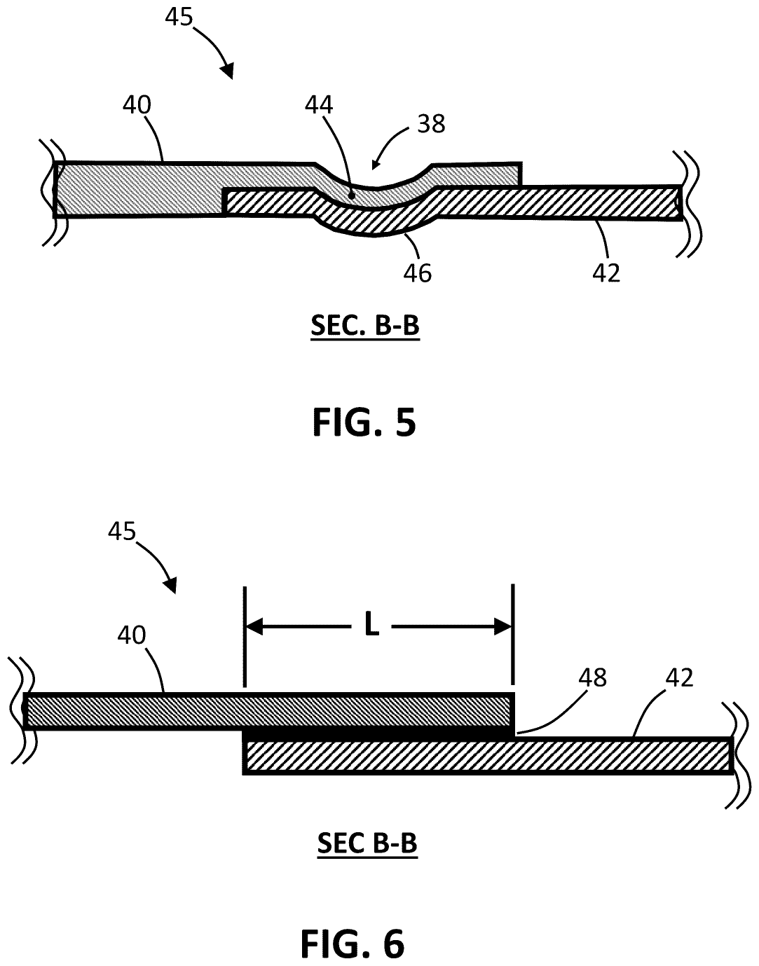

FIG. 5 shows a schematic cross-section view (B-B) of an example of an overlapping bond joint 45 with a pair of matching, mechanical interlocking features (e.g., first bump 44 and matching second bump 46), according to the present disclosure. Recessed dimple 38 may be created by pushing, forging, or punching a semispherical tool (not shown) into upper sheet 40 in a direction perpendicular to a broad plane of upper sheet 40. Plastically deforming dimple 38 then plastically deforms first bump 44 in layer 40, which, in turn, plastically deforms lower sheet 42 to create a matching second bump 46 that mechanically interlocks with upper bump 44. The two interlocking bumps 44 and 46 increase the bond shear strength of overlapping bond joint 45. In some embodiments, upper sheet 40 may comprise a metallic material. In other embodiments, lower sheet 42 may comprise a polymer fiber/composite material. In other embodiments, upper sheet 40 may comprise a polymer fiber/composite material and lower sheet 42 may comprise a metallic material.

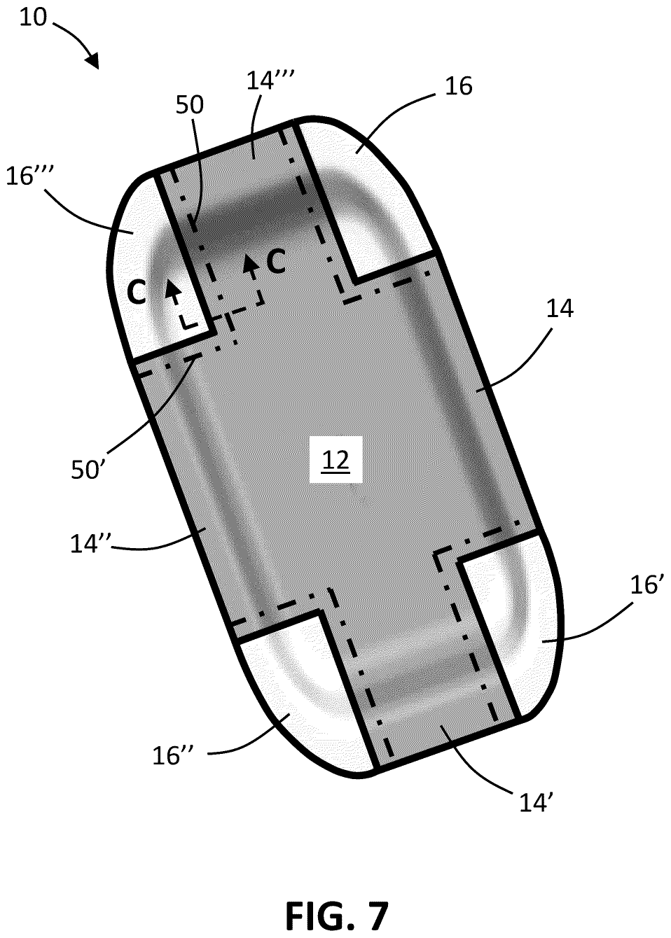

FIG. 6 shows a schematic cross-section view (B-B) of an example of an overlapping bond joint 45 with an optional, non-conductive interlayer 48 disposed in-between upper sheet 40 and lower sheet 42, according to the present disclosure. Bond overlap distance, L, is identified. Non-conductive interlayer 48 may comprise an array of non-conductive fibers (e.g., glass fibers), which may be a woven mesh (or “veil”); or which may be an array of randomly-oriented, non-conductive fibers. The purpose of non-conductive interlayer 48 is to prevent galvanic corrosion in hybrid metal/composite trays that use carbon or graphite conductive polymer/fiber composite corner inserts 16, 16′, 16″, 16′″ bonded to a metallic partial tray 12. A thickness of non-conductive interlayer 48 may range from about 0.005 mm to about 0.1 mm.

Referring still to FIG. 6, in some embodiments, the bond overlap distance, L, may range from about 15 mm to about 50 mm. A thickness, tₘ, of a metallic sheet (40 or 42) used for partial tray 12 may range from about 1 mm to about 2 mm. A thickness, t_{c}, of a polymer/fiber composite sheet (40 or 42) used for making rounded corner inserts 16, 16′, 16″, 16′″ may range from about 3 mm to about 6 mm. The thickness, t_{c}, of a polymer/fiber composite corner sheet may be greater than the thickness, tₘ, of a metal sheet used in hybrid tray 10. An optimum value of the bond overlap length, Lₒₚ, may be calculated by using the following formula: Lₒₚ=tensile strength of metal sheet times tₘ divided by resin shear strength. An example of an optimum overlap bond length, Lₒₚₜ, to transfer a load from a high strength (e.g., 780 MPa) steel sheet with a thickness, tₘ=2 mm, to a polymer/fiber composite sheet may be Lₒₚₜ=32 mm. The overlapping bond length, L, may range from about 15 mm to about 50 mm, depending on different strengths of steel and polymer/fiber composite material.

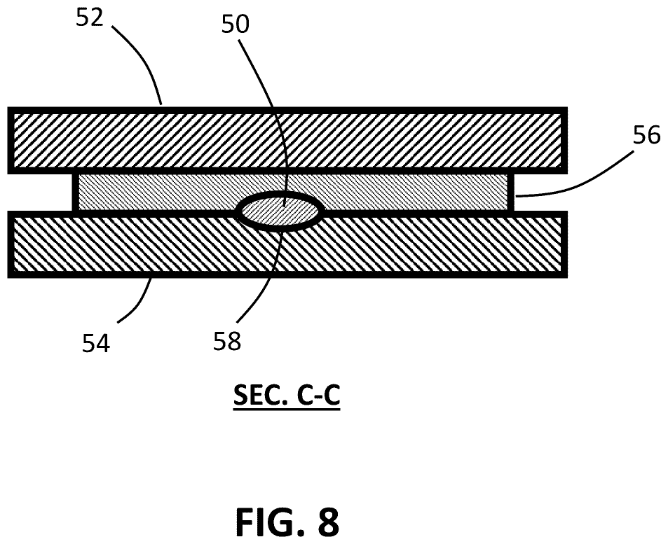

FIG. 7 shows a schematic perspective view of an example of a hybrid tray 10, according to the present disclosure. In this embodiment, a temporary gasket 50 (and 50′, indicated by the dashed lines) may be used to control and/or prevent undesirable, excess resin infiltration that may occur during a RTM operation.

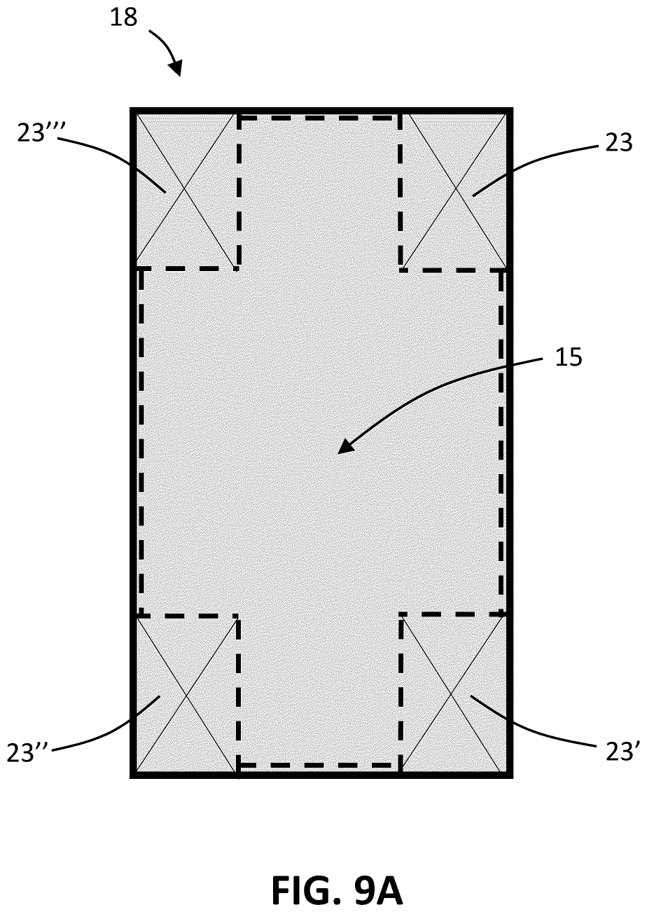

FIG. 8 shows a schematic cross-section view (C-C) of an example of an injection-molded bond joint with a removable gasket 50 that controls and reduces undesirable, excess flow of injected resin during RTM operations, according to the present disclosure. Gasket 50 may be partially-recessed inside of an optional groove 58 that is machined into a lower tool 54. Part 56 being injection molded may be sandwiched and held in-between upper tool 52 and lower tool 54. Gasket 50 may be removed after completing the injection molding procedure.

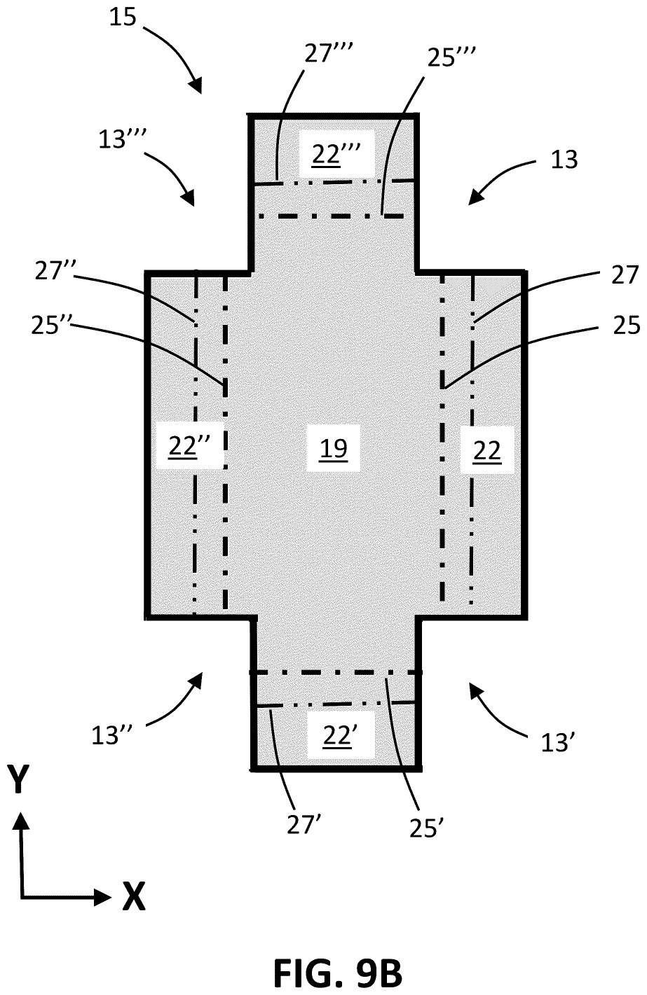

FIG. 9A shows a schematic plan view of an example of a rectangular metal sheet 18 used to make a cruciform-shaped sheet 15, according to the present disclosure. Cruciform-shaped sheet 15 initially starts out as a rectangular-shaped, blank metal sheet 18. Then, four rectangular “cutout” corners 23, 23′, 23″, and 23′″ are cutout (e.g., by a laser, plasma, wire EDM, or water-jet) and removed from metal sheet 18 to leave a cruciform shapes sheet 15 (defined by the dashed lines).

FIG. 9B shows a schematic plan view of an example of a cruciform-shaped metal sheet 15, according to the present disclosure. Removing the cutout corners 23, 23′, 23″, and 23′″ from rectangular metal sheet 18 leaves a cruciform-shaped metal sheet 15 that looks similar to the white “Swiss-Cross” shape on the flag of Switzerland (which has a red background). The term “Swiss-Cross shape” is broadly defined as including both square-shaped and rectangular-shaped cruciform-shaped outlines of sheet 15. A “Swiss-Cross” shape is also broadly defined as a cruciform shape 15 having a rectangular central zone 19 with four, rectangular tabs/wings 22, 22′, 22″, and 22′″ that protrude/extend outwards from rectangular central zone 19. The four, rectangular tabs/wings 22, 22′, 22″, and 22′″ define four, recessed corners 13, 13′, 13″, and 13′″, respectively, of cruciform-shaped metal sheet 15. Tabs/wings 22, 22′, 22″, and 22′″ may be press-formed and bent upwards in a press or forming tool (not shown) to form four raised edges 36, 36′, etc. (see FIG. 3A) around the edges of cruciform-shaped sheet 15. Approximate locations of respective pairs of bending lines 25, 25′, 25″, 25′″ and 27, 27′, 27″, 27′″, are shown in FIG. 9B. Cruciform-shaped metal sheet 15 may be symmetric about both the X-axis and the Y-axis, as shown in FIG. 9B.

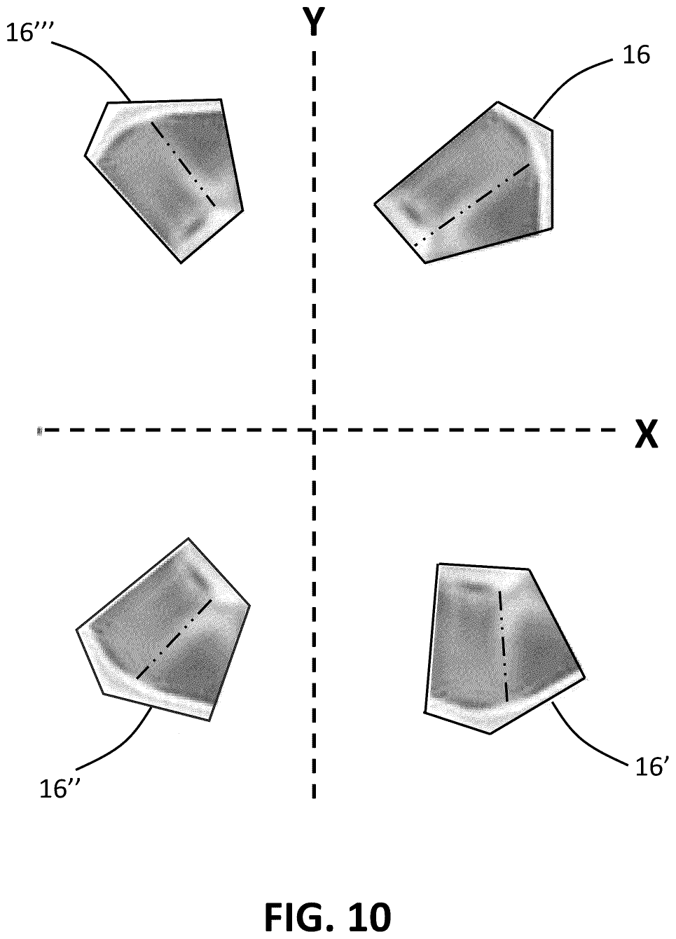

FIG. 10 shows a schematic, perspective view of an example of four, rounded corner inserts 16, 16′, 16″, and 16′″, according to the present disclosure. Four, rounded corner inserts 16, 16′, 16″, and 16′″ may be made of a polymeric material, a polymer/fiber composite material, a thermoset polymer/fiber composite material, a thermoplastic polymer/fiber composite material, or a metal alloy. In some embodiments, rounded corner inserts 16, 16′, 16″, and 16′″ may initially have a polygonal shape before being press-formed into their three-dimensional, rounded shape. Four, rounded corner inserts 16, 16′, 16″, and 16′″ may be fabricated into their desired, three-dimensional, rounded corner shapes by draping or placing an initially flat (dry) polygonal fibrous preform insert, or a polygonal polymer/fiber composite prepreg insert, on a molding tool (not shown); and then either: (A) injection molding the fibrous preform insert using a RTM process (for thermoset resin), or (B) press-forming and curing thermoplastic polymer/fiber composite prepreg corner inserts into their desired, three-dimensional rounded shapes in a press (not shown) using a molding tool (not shown), at an elevated temperature.

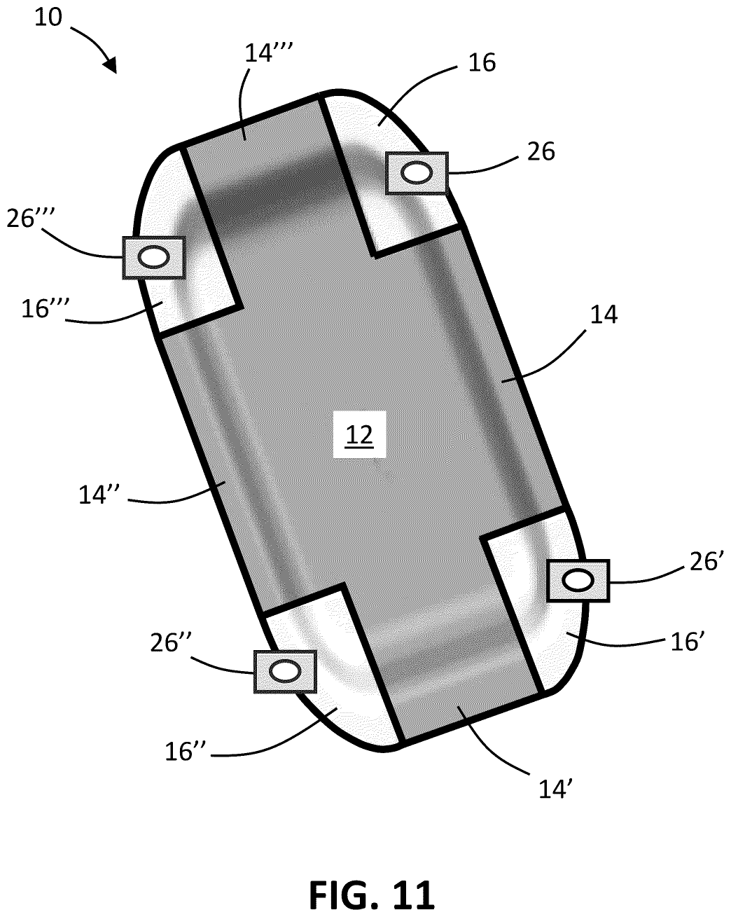

FIG. 11 shows a schematic perspective view of an example of a hybrid tray 10 with four, corner injection ports 26, 26′, 26″, 26′″ that may be used for injecting resin into the four, rounded fibrous preform corner inserts 16, 16′, 16″, and 16′″, respectively, of partial tray 12 using, for example, a RTM process, according to the present disclosure.

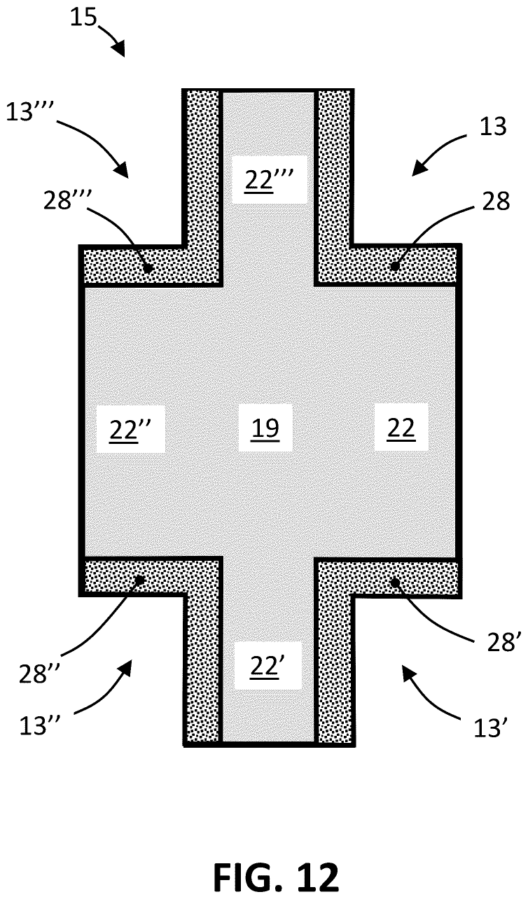

FIG. 12 shows a schematic plan view of an example of a cruciform-shaped metal sheet 15 with L-shaped, surface-treated, overlapping second bond surfaces 28, 28′, 28″, and 28′″, according to the present disclosure. Surface-treated, overlapping second bond surfaces 28, 28′, 28″, and 28′″ may have the same shape (width) and location as regions where rounded corner inserts 16, 16′, 16″, and 16′″ overlap, and are attached to, four recessed corners 13, 13′, 13″, and 13′″ of cruciform-shaped metal sheet 15. In one embodiment, overlapping second bond surfaces 28, 28′, 28″, and 28′″ may be laser-ablated to create a roughened surface comprising a plurality of laser-ablated features (e.g., pits or bumps), which are illustrated by the “random dot fill pattern” used in FIG. 12. Alternatively, in another embodiment, overlapping second bond surfaces 28, 28′, 28″, and 28′″ may be plasma-treated with a plasma to increase the overlapping surface's chemical bond energy, which enhances the chemical bond strength of metal-to-polymer/fiber composite overlapping bond joints (See FIGS. 3A and 3B).

Referring still to FIG. 12, in another embodiment, overlapping second bond surfaces 28, 28′, 28″, and 28′″ may be pre-treated with a two-step process, comprising: (1) laser-ablating each overlapping second bond surface 28, 28′, 28″, or 28′″; and (2) exposing each laser-ablated overlapping second bond surface 28, 28′, 28″, or 28′″ to a plasma to increase the surfaces' chemical bond energy. The laser-ablation treatment may be performed before plasma treatment, or visa-versa.

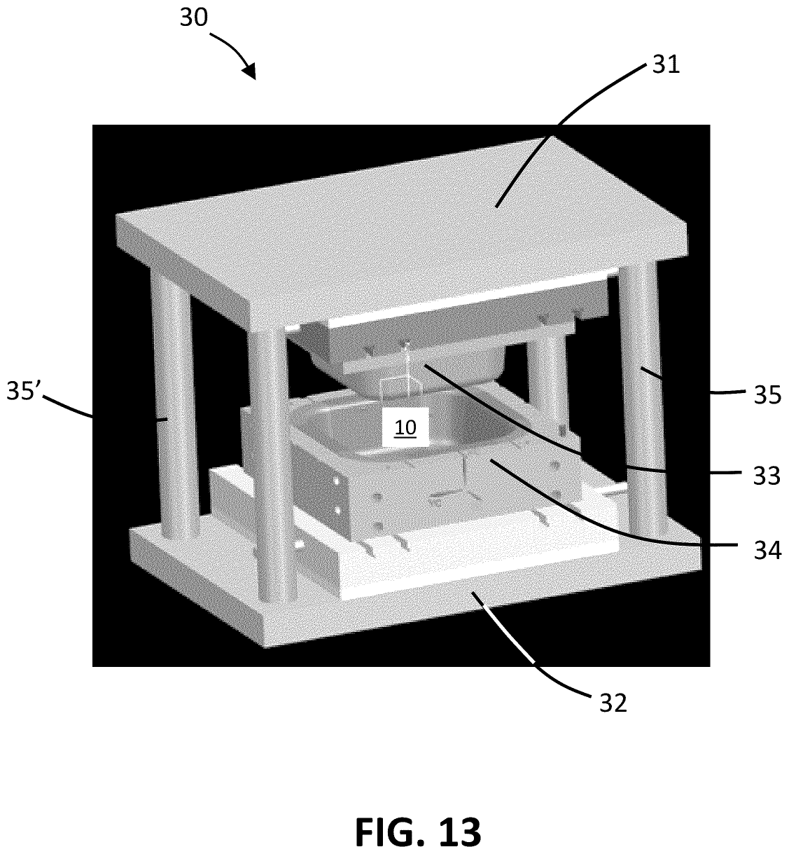

FIG. 13 shows a schematic perspective view of an example of a press 30 that may be used for press-forming a hybrid tray 10, according to the present disclosure. Press 30 comprises an upper, moveable platen 31 and a lower, fixed base platen 32 that is held apart by four, movable cylinders (e.g., hydraulic pistons) 35, 35′, etc. that move the upper, movable platen 31 up or down. A female die 34 (i.e., the molding tool) is fixed to base 32 and holds partial tray 12 and four rounded corner inserts 16, 16′, 16″, 16′″ in a proper alignment prior to press-forming the hybrid tray 10. Upper male die 33 is attached to upper platen 31, and upper male die 33 moves downwards to compress and press-form one or more parts against female die 34.

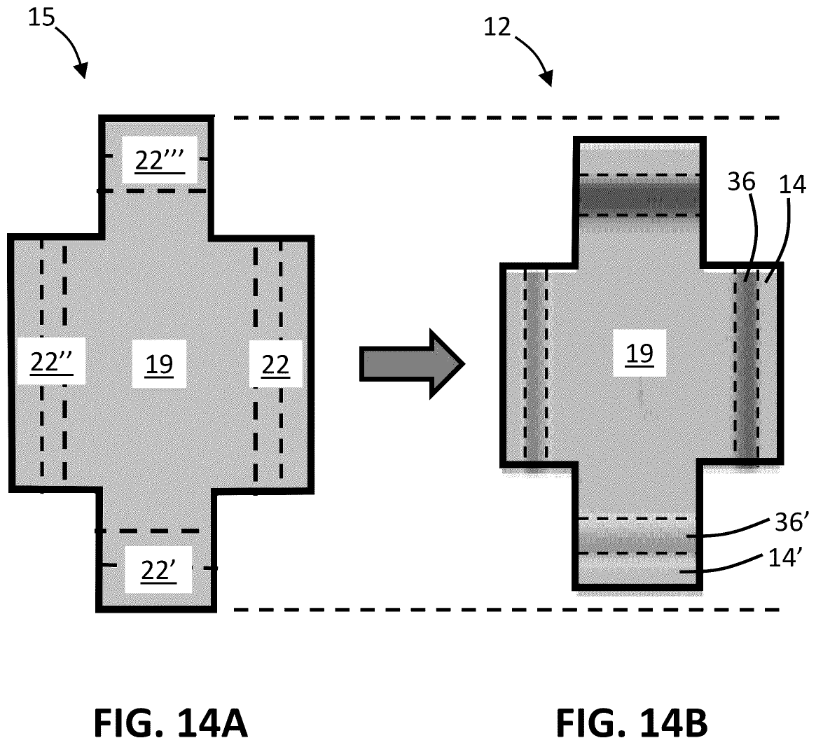

FIG. 14A shows a schematic plan view of an example of a cruciform-shaped metal sheet 15 before press-forming sheet 15 into a partial tray 12, according to the present disclosure. Cruciform-shaped metal sheet 15 comprises a rectangular central zone 19 and four, integral, rectangular tabs/wings 22, 22′, 22″, and 22′″.

FIG. 14B shows a schematic plan view of an example of a press-formed, cruciform-shaped partial tray 12 after press-forming the cruciform-shaped metal sheet 15 to form partial tray 12 with turned-up (raised, vertical) edges 36, 36′, etc. and horizontal top flanges 14, 14′, etc., according to the present disclosure. Turned-up (raised vertical) edges 36, 36′, etc. and horizontal top flanges 14, 14′, etc., may be fabricated by bending tabs/wings 22, 22′, 22″, and 22′″ upwards and outwards using single-curvature bends (e.g., by press-forming tabs/wings 22, 22′, 22″, and 22′″ against a molding tool.)

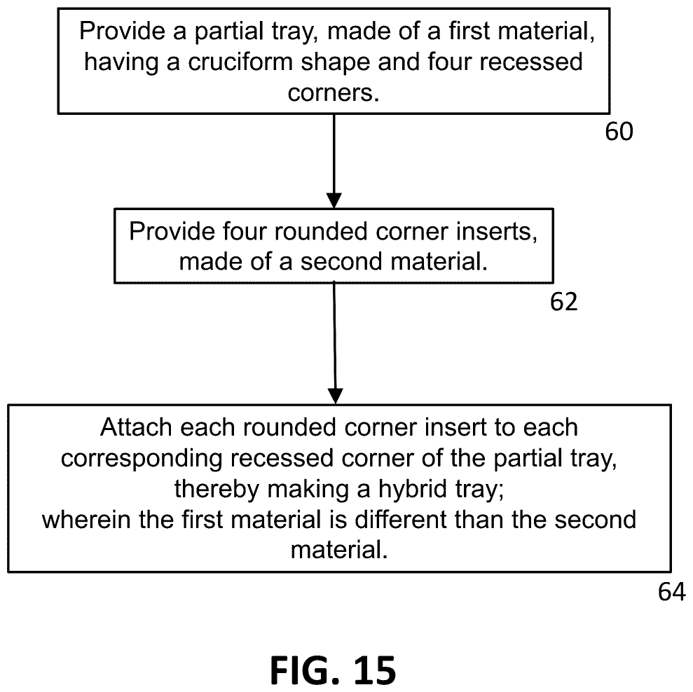

FIG. 15 shows an example of a process flow chart for manufacturing a hybrid tray, according to the present disclosure. First, step 60 comprises providing a partial tray, made of a first material, and having a cruciform shape with four recessed corners. Then, step 62 comprises providing four, rounded corner inserts, made of a second material. Finally, step 64 comprises attaching each respective one of the four, rounded corner inserts to each respective one of the four recessed corners of the partial tray, thereby making a hybrid tray. In this embodiment, the first material may be different than the second material.

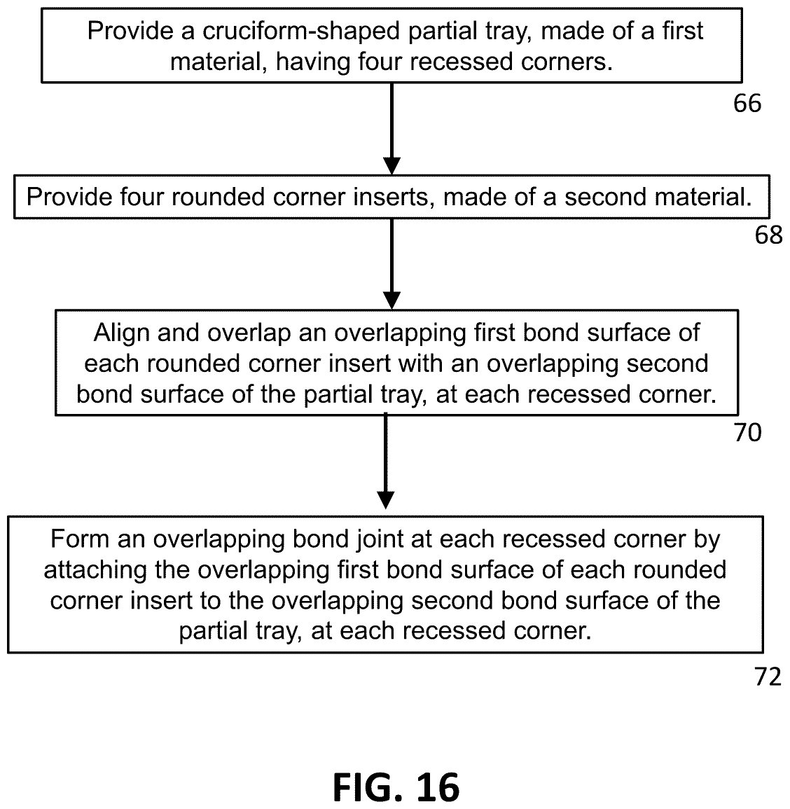

FIG. 16 shows another example of a process flow chart for manufacturing a hybrid tray, according to the present disclosure. First, step 66 comprises providing a cruciform-shaped partial tray, made of a first material, and having four recessed corners. Then, step 68 comprises providing four, rounded corner inserts, made of a second material. Then, step 70 comprises aligning and overlapping an overlapping first bond surface of each rounded corner insert with a corresponding overlapping second bond surface of the partial tray, at each recessed corner. Finally, step 72 comprises forming an overlapping bond joint by attaching the overlapping first bond surface of each rounded corner insert to the corresponding overlapping second bond surface of the partial tray, at each recessed corner.

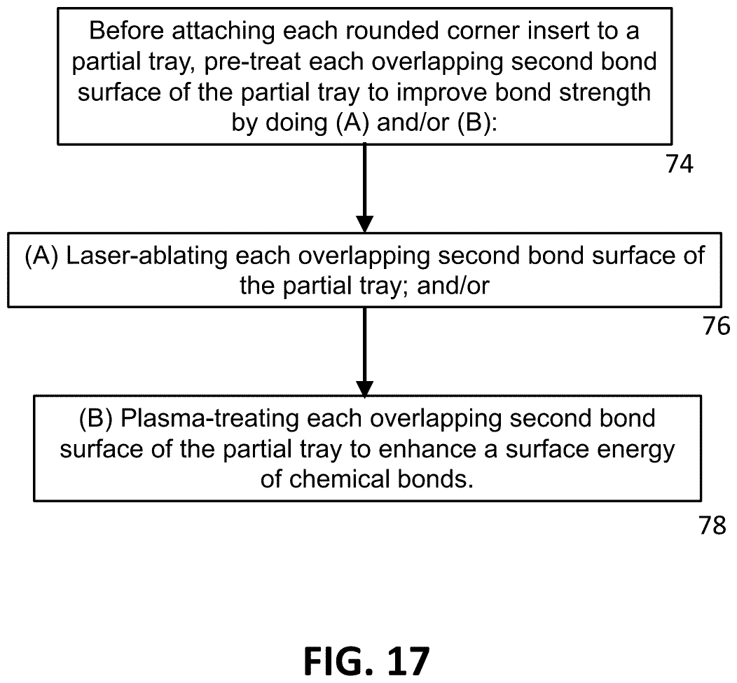

FIG. 17 shows another example of a process flow chart for manufacturing a hybrid tray, according to the present disclosure. First, step 74 comprises: before attaching each rounded corner insert to each recessed corner of a partial tray, pre-treating each overlapping second bond surface of the partial tray to improve bond strength by doing (A) and/or (B), wherein (A) comprises laser-ablating each overlapping second bond surface of the partial tray (see step 76), and/or (B) comprises plasma-treating each overlapping second bond surface of the partial tray, which enhances a surface energy of chemical bonds (see step 78).

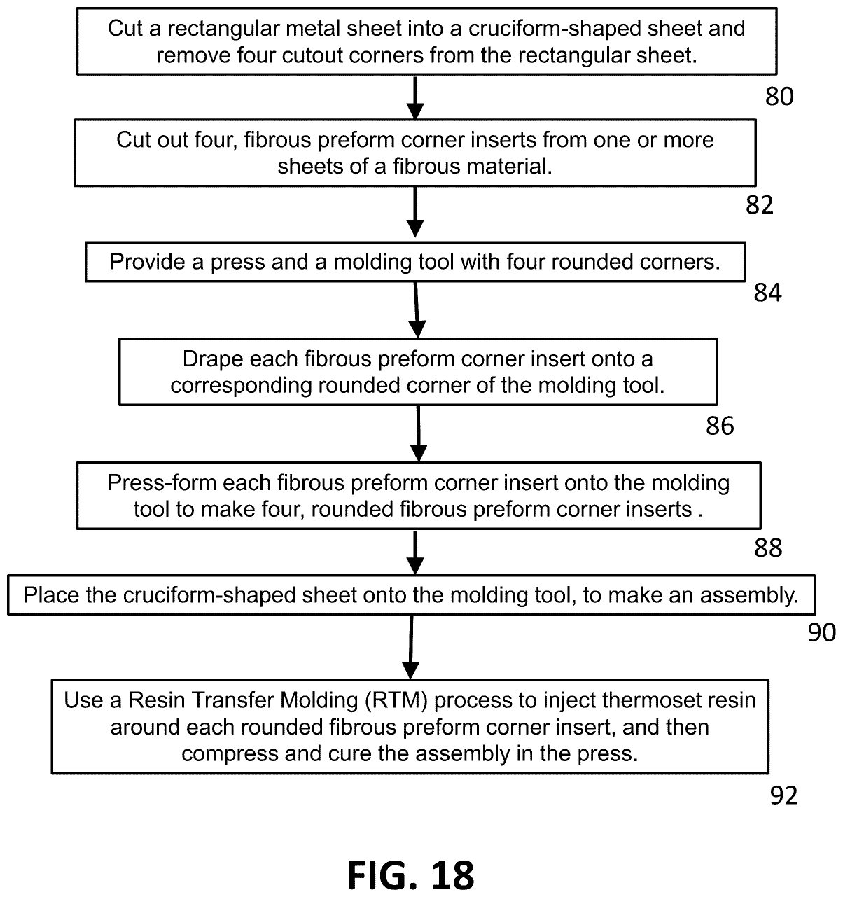

FIG. 18 shows another example of a process flow chart for manufacturing a hybrid tray, according to the present disclosure. First, step 80 comprises cutting a rectangular sheet of metal into a cruciform-shaped sheet and removing four cutout corners from the rectangular metal sheet. Then, step 82 comprises cutting out four, fibrous preform corner inserts from one or more sheets of a fibrous material. Then, step 84 comprises providing a press and a molding tool with four rounded corners. Then, step 86 comprises draping each fibrous perform corner insert onto a corresponding rounded corner of the molding tool. Then, step 88 comprises press-forming each fibrous preform corner insert on the molding tool to make four, rounded fibrous preform corner inserts. Then, step 90 comprises placing the cruciform-shaped sheet onto the molding tool, thereby making an assembly. Finally, step 92 comprises: using a RTM process to inject thermoset resin around each respective one of the four, rounded fibrous preform corner inserts and the cruciform-shaped sheet, followed by compressing and curing the assembly.

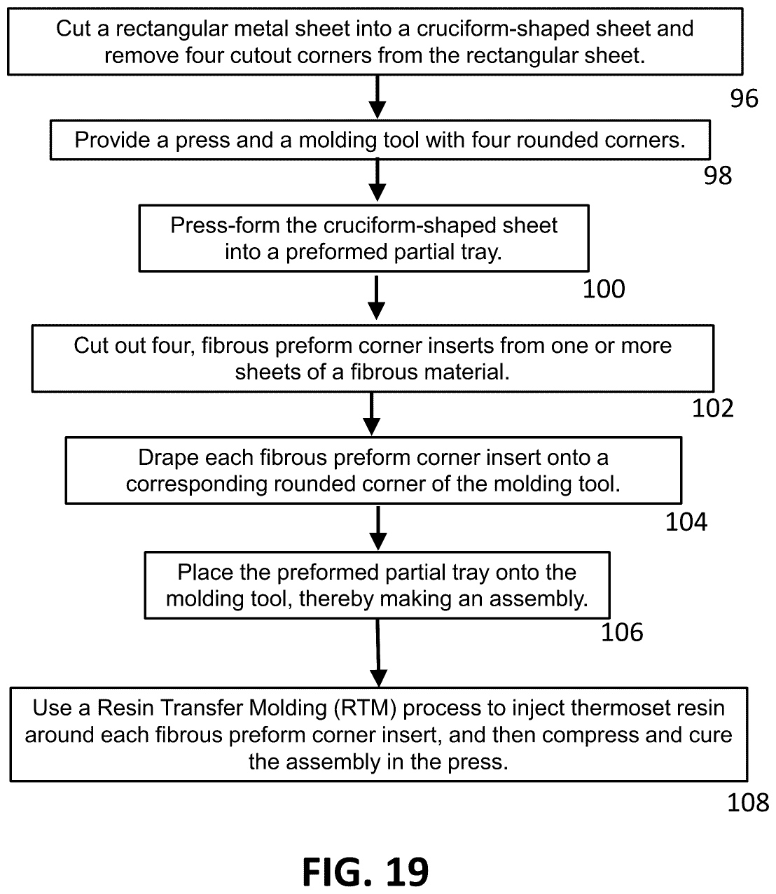

FIG. 19 shows another example of a process flow chart for manufacturing a hybrid tray, according to the present disclosure. First, step 96 comprises cutting a rectangular sheet of metal into a cruciform-shaped sheet and removing four cutout corners from the rectangular metal sheet. Then, step 98 comprises providing a press and a molding tool with four rounded corners. Then, step 100 comprises press-forming the cruciform-shaped sheet into a preformed partial tray. Then, step 102 comprises cutting out four, fibrous preform corner inserts from one or more sheets of a fibrous material. Then, step 104 comprises draping each fibrous preform corner insert onto a corresponding rounded corner of the molding tool. Then, step 106 comprises placing the preformed partial tray onto the molding tool, thereby making an assembly. Finally, step 108 comprises using a RTM process to inject thermoset resin around each respective one of the four, fibrous preform corner inserts and the preformed partial tray, followed by compressing and curing the assembly.

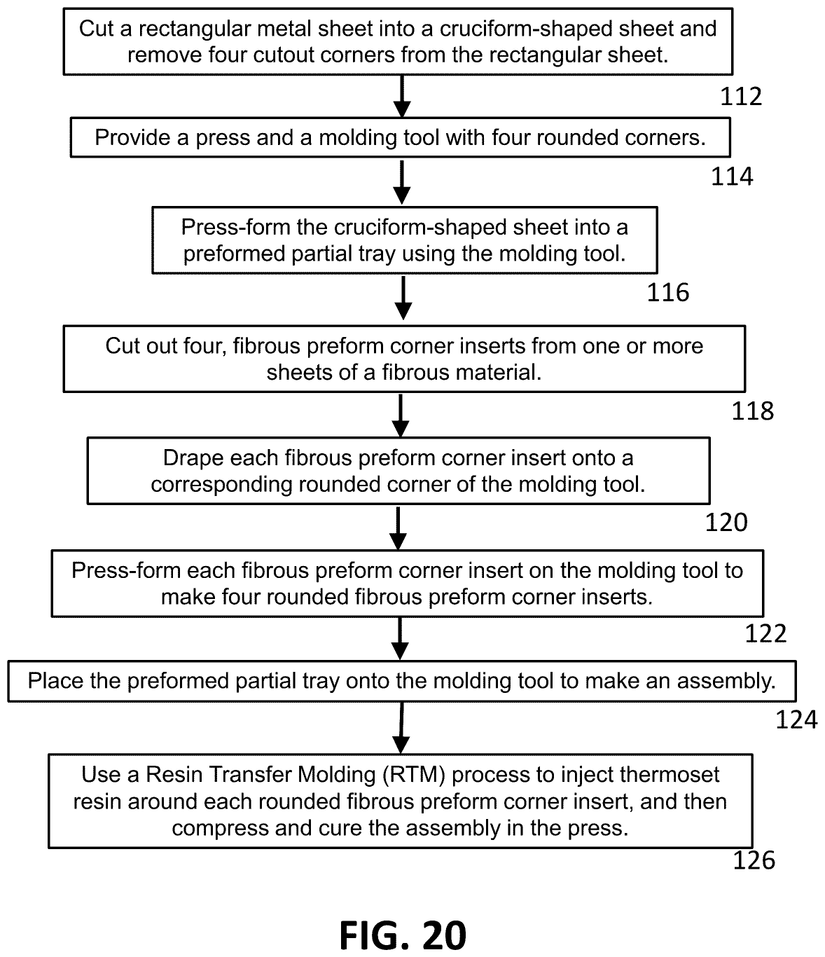

FIG. 20 shows another example of a process flow chart for manufacturing a hybrid tray, according to the present disclosure. First, step 112 comprises cutting a rectangular sheet of metal into a cruciform-shaped sheet and removing four cutout corners from the rectangular metal sheet. Then, step 114 comprises providing a press and a molding tool with four rounded corners. Then, step 116 comprises press-forming the cruciform-shaped sheet into a preformed partial tray using the molding tool. Then, step 118 comprises cutting out four, fibrous preform corner inserts from one or more sheets of a fibrous material. Then, step 120 comprises draping each fibrous preform corner inserts onto a corresponding rounded corner of the molding tool. Then, step 122 comprises press-forming the four, fibrous preform corner inserts on the molding tool to make four, rounded fibrous preform corner inserts. Step 124 comprises placing the preformed partial tray sheet onto the molding tool, thereby making an assembly. Finally, step 126 comprises using a RTM process to inject thermoset resin around each respective one of the four, rounded fibrous preform corner inserts and the preformed partial tray, followed by compressing and curing the assembly.

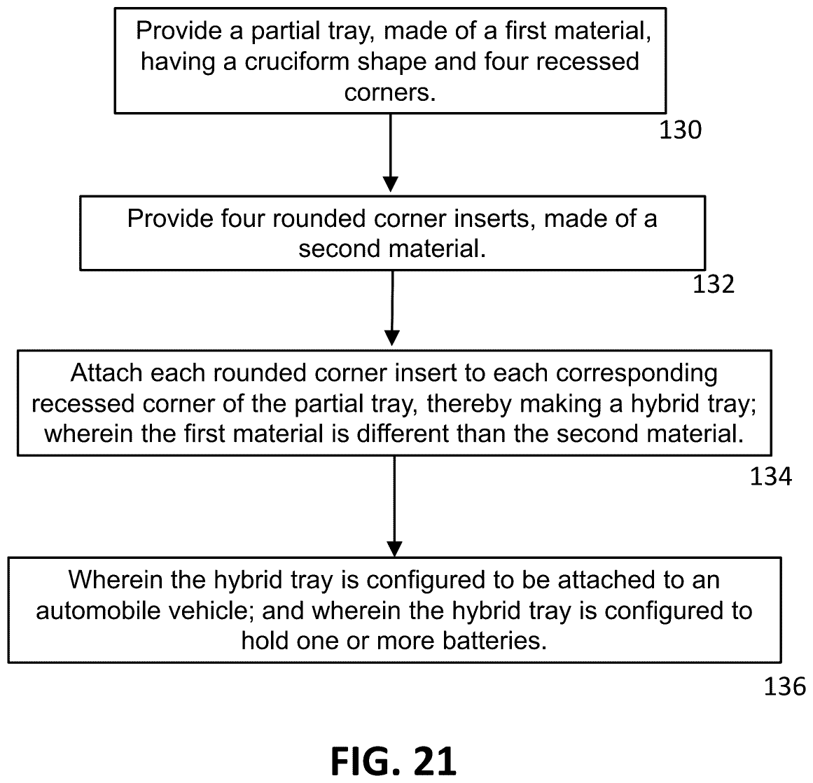

FIG. 21 shows another example of a process flow chart for manufacturing a hybrid tray, according to the present disclosure. First, step 130 comprises providing a partial tray, made of a first material, and having four recessed corners. Then, step 132 comprises providing four rounded corner inserts, made of a second material. Then, step 134 comprises attaching each rounded corner insert to each corresponding recessed corner of the partial tray, thereby making a hybrid tray, wherein the first material may be different than the second material. Finally, in step 136, the hybrid tray is configured to be attached to an automobile vehicle; and the hybrid tray is configured to hold one or more batteries.

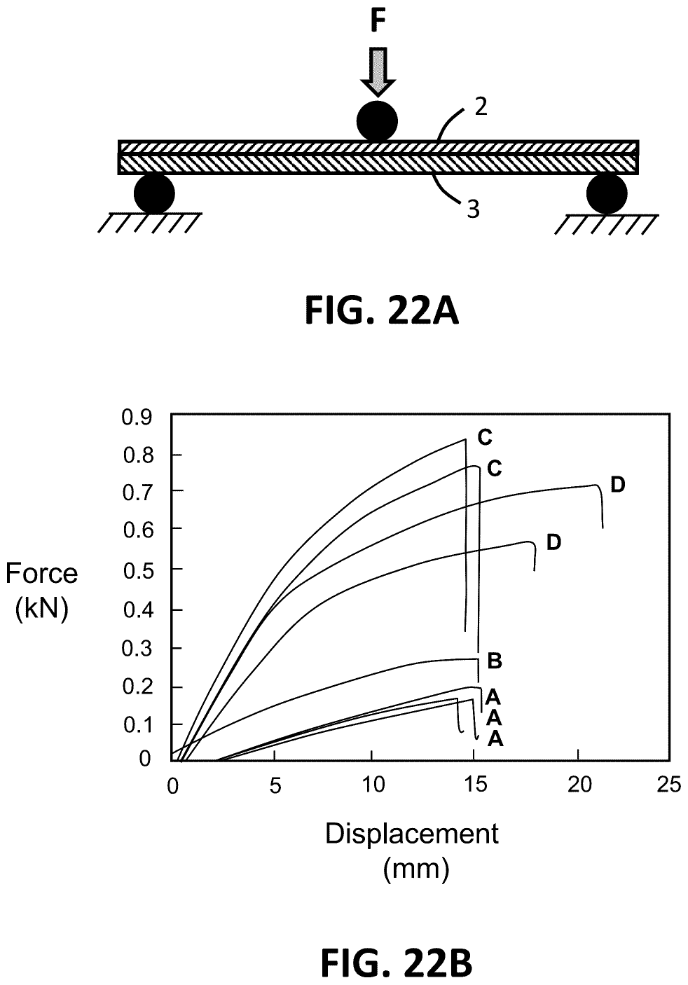

FIG. 22A shows a schematic elevation view of an example of a generic 3-point bending test configuration for testing a laminated sheet 2 of a first material bonded to sheet 3 of a second material in 3-point bending, according to the present disclosure, where the first material is different than the second material.

FIG. 22B shows graphs of multiple Force (kN) vs Displacement (mm) curves to failure for laminated, three-point bending samples of a steel sheet bonded (i.e., co-molded) to a polymer/fiber composite sheet, according to the present disclosure. Bare (untreated) steel sheets are compared to laser-ablated steel sheets, which are laminated to polymer/fiber composite sheets. Four different types of 3-point, laminated bending samples were tested to failure (i.e., delamination by shearing): types A, B, C, and D. Table 1 compares the test results. Sample A was a single sheet of NCF 0/90/90/0 polymer/fiber composite (without any steel sheet bonded to it). Sample B was a bare (untreated) steel sheet (420 LA steel) bonded (co-molded) to the NCF 0/90/90/0 polymer/fiber composite laminate. In samples C and D, the steel sheets were pre-treated with laser ablation prior to bonding (co-molding) to the NCF 0/90/90/0 polymer/fiber composite laminate sheet. Sample C used 420LA steel, and Sample D used 420LA HDG steel. The sample dimensions were 25.4 mm×152.4 mm×1.5 mm for sample A, and 25.4 mm×152.4 mm×2.3 mm for samples B, C, and D. From Table 1, the failure force (Maximum Force) approximately doubled from 0.39 kN (Sample B) to 0.8 kN (Sample C) when the steel sheet was pre-treated with laser ablation. Note: “NCF” means “Non-Crimp Carbon Fiber” polymer composite, and “HDG” means “Hot Dipped Galvanized” steel.

TABLE 1
Results for 3-Point Bending Tests for Bare (Untreated) Steel vs
Laser-Ablated Steel Co-Molded to Polymer/Fiber Composite Sheets

| | Polymer/ | | | |
|---|---|---|---|---|
| | fiber | | Maximum | Displacement |
| | Composite | | Force | at Failure |
| Sample | Sheet | Steel Sheet Treatment | (kN) | (mm) |
| A | NCF 0/90/ | No Steel Sheet | 0.17 | 14.7 |
| | 90/0 | (Composite Laminate | | |
| | | only) | | |
| B | NCF 0/90/ | Untreated Bare Steel + | 0.39 | 12.81 |
| | 90/0 | Composite Laminate | | |
| C | NCF 0/90/ | Laser-Ablated Steel + | 0.8 | 14.88 |
| | 90/0 | Composite Laminate | | |
| D | NCF 0/90/ | Laser-Ablated HDG | 0.6 | 19.16 |
| | 90/0 | Steel + Composite | | |
| | | Laminate | | |

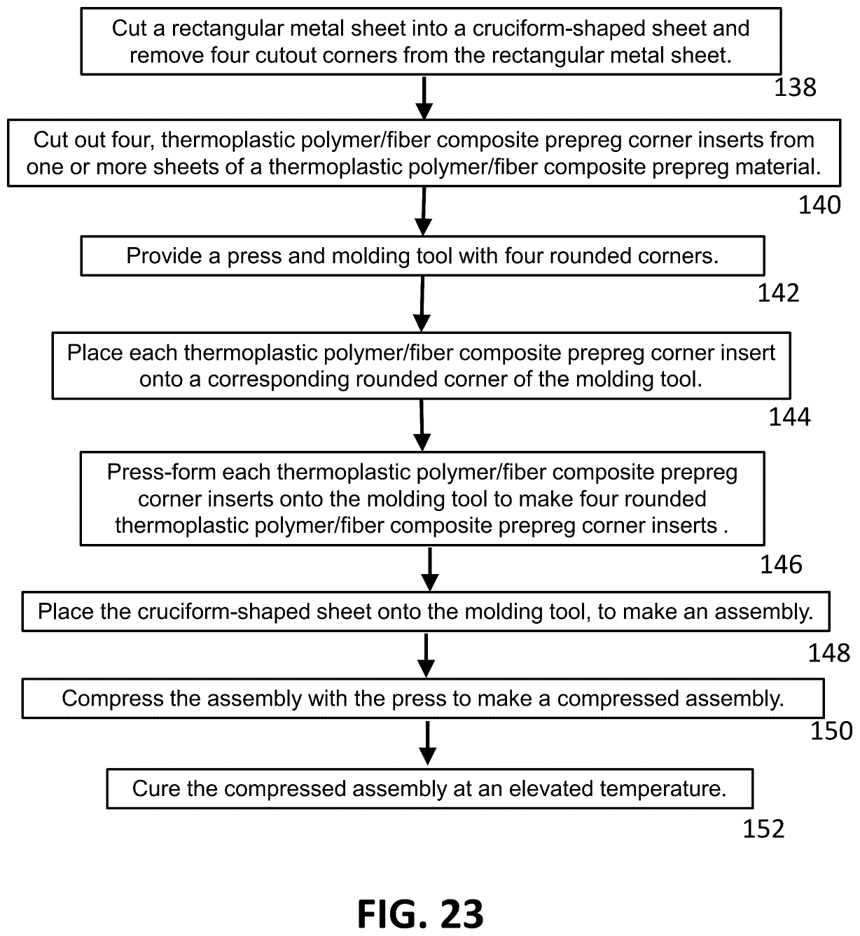

FIG. 23 shows an example of a process flow chart for manufacturing a hybrid tray, according to the present disclosure. Step 138 comprises cutting a rectangular metal sheet into a cruciform-shaped sheet, and then removing four cutout corners from the rectangular metal sheet. Step 140 comprises cutting out four, thermoplastic polymer/fiber composite prepreg corner inserts from one or more sheets of a thermoplastic polymer/fiber composite prepreg material. Step 142 comprises providing a press and a molding tool with four rounded corners. Step 144 comprises placing each respective one of the four, thermoplastic polymer/fiber composite prepreg corner inserts onto each respective one of the four rounded corners of the molding tool. Step 146 comprises press-forming the four, thermoplastic polymer/fiber composite prepreg corner inserts on the four rounded corners of the molding tool to make four, rounded thermoplastic polymer/fiber composite prepreg corner inserts. Step 148 comprises placing the cruciform-shaped sheet onto the molding tool, thereby making an assembly comprising the cruciform-shaped sheet and the four, rounded thermoplastic polymer/fiber composite prepreg corner inserts. Step 150 comprises compressing the assembly using the press to make a compressed assembly. Finally, step 152 comprises curing the compressed assembly at an elevated temperature.

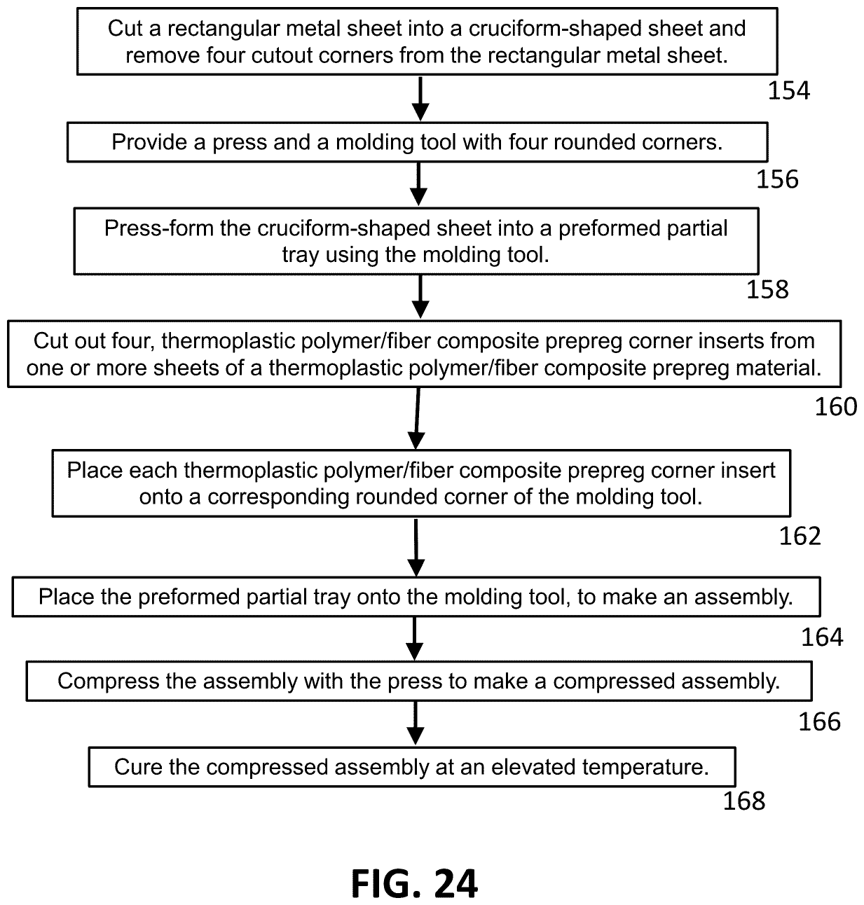

FIG. 24 shows an example of a process flow chart for manufacturing a hybrid tray, according to the present disclosure. Step 154 comprises cutting a rectangular metal sheet into a cruciform-shaped sheet, and then removing four cutout corners from the rectangular metal sheet. Step 156 comprises providing a press and a molding tool having four rounded corners. Step 158 comprises press-forming the cruciform-shaped sheet into a preformed partial tray using the molding tool. Step 160 comprises cutting out four, thermoplastic polymer/fiber composite prepreg corner inserts from one or more sheets of a thermoplastic polymer/fiber composite prepreg material. Step 162 comprises placing each respective one of the four, thermoplastic polymer/fiber composite prepreg corner inserts on each respective one of the four rounded corners of the molding tool. Step 164 comprises placing the preformed partial tray onto the molding tool, thereby making an assembly comprising the preformed partial tray and the four, thermoplastic polymer/fiber composite prepreg corner inserts. Step 166 comprises compressing the assembly using the press to make a compressed assembly. Finally, step 168 comprises curing the compressed assembly at an elevated temperature.

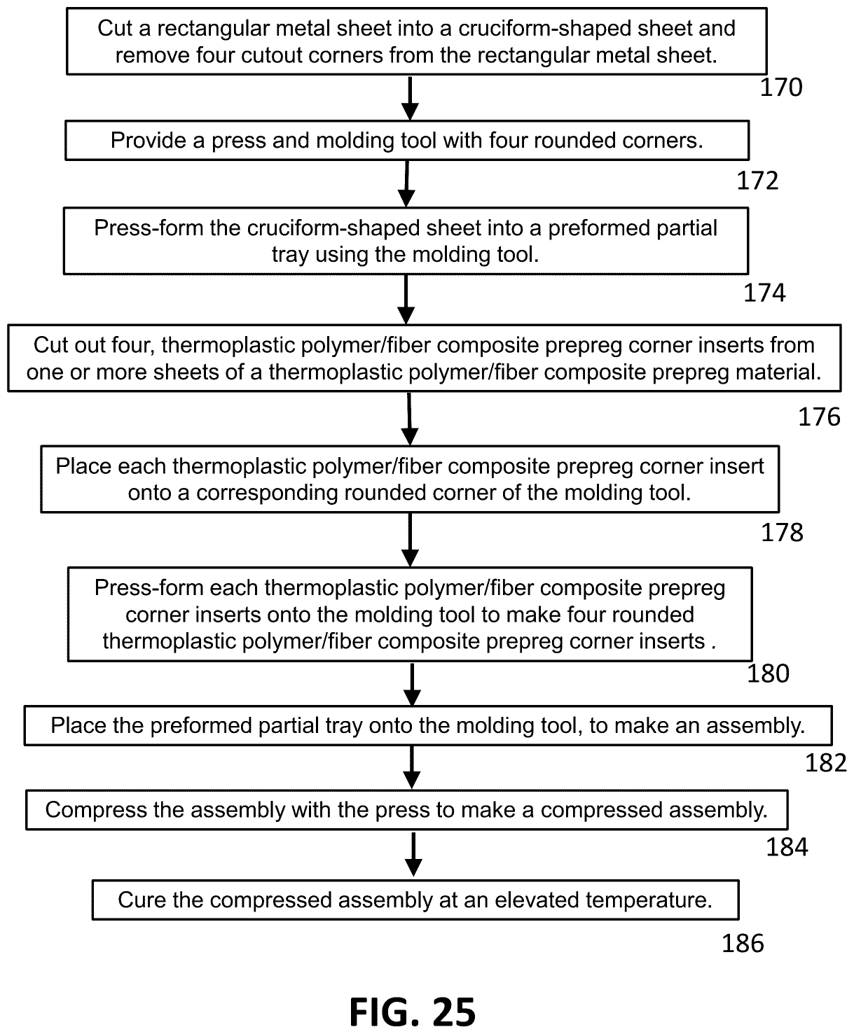

FIG. 25 shows an example of a process flow chart for manufacturing a hybrid tray, according to the present disclosure. Step 170 comprises cutting a rectangular metal sheet into a cruciform-shaped sheet, and then removing four cutout corners from the rectangular metal sheet. Step 172 comprises providing a press and a molding tool having four rounded corners. Step 174 comprises press-forming the cruciform-shaped sheet into a preformed partial tray using the molding tool. Step 176 comprises cutting out four, thermoplastic polymer/fiber composite prepreg corner inserts from one or more sheets of a thermoplastic polymer/fiber composite prepreg material. Step 178 comprises placing each respective one of the four, thermoplastic polymer/fiber composite prepreg corner inserts onto each respective one of the four rounded corners of the molding tool. Step 180 comprises press-forming the four, thermoplastic polymer/fiber composite prepreg corner inserts on the molding tool, thereby making four, rounded thermoplastic polymer/fiber composite prepreg corner inserts. Step 182 comprises placing the preformed partial tray onto the molding tool, thereby making an assembly comprising the four, rounded thermoplastic polymer/fiber composite prepreg corner inserts and the preformed partial tray. Step 184 comprises compressing the assembly using the press to make a compressed assembly. Finally, step 186 comprises curing the compressed assembly at an elevated temperature.

In some embodiments, welding of adjacent metal joints is not required to fabricate a hybrid tray 10.

In some embodiments, a hybrid tray 10 may be configured to be attached to a vehicle, and hybrid tray 10 may be configured to hold one or more batteries.

In some embodiments, a hybrid tray 10 may be fabricated from two different materials, where the two different materials are two different alloys of steel. A first steel alloy may be used to fabricate partial tray 12. This first steel alloy may have a high strength and also have a low ductility. Since cruciform-shaped metal sheet 15 (see FIG. 14A) has four tabs/wings 22, 22′, 22″, and 22′″, then press-forming the raised edges 36, 36′, etc. (See FIG. 3A)) and horizontal top flanges 14, 14′, etc. (See FIG. 3A) by bending up tabs/wings 22, 22,′ 22″, and 22′″ of cruciform-shaped tray 15 only require making single-curvature (i.e., single-axis) bends (See FIGS. 14A and 14B). Making single-curvature (i.e., single-axis) bends helps to reduce or eliminate problems with wrinkling and tearing of the high-strength, steel alloy cruciform-shaped sheet 15 during press-forming. Additionally, a second steel alloy, that is different from the first steel alloy, may be used press-form the four, rounded corner inserts 16, 16′, 16″, and 16′″. The second steel alloy may have a relatively lower yield strength, and also have a relatively higher ductility than the first steel alloy. The mechanical properties of the second steel alloy permit deep press-forming of the four, rounded corner inserts 16, 16′, 16″, and 16′″ that are press-formed to have complex, curved surface profiles (see FIG. 10). Each respective one of the four, rounded corner inserts 16, 16′, 16″, or 16′″ may be welded (e.g., robotically laser-welded) to each respective one of the four, recessed corners 13, 13′, 13″, and 13′″ of partial tray 12 to make a leak-tight, hybrid tray 10 with a single, continuous surface.

In some embodiments, all of the four, polymer/fiber composite prepreg corner inserts 16, 16′, 16″, 16′″ may be simultaneously press-formed on the molding tool using a press.

In some embodiments, the hybrid tray 10 has a single, continuous surface that is leak-tight.

In some embodiments, the four, rounded corner inserts 16, 16′, 16″, and 16′″ may be manufactured by 3-D printing, casting, or injection molding.

In some embodiments, a method of manufacturing a hybrid tray may comprise combining stamping (press-forming) processes with over-molding (co-molding) methods, such as Resin Transfer Molding (RTM) or compression molding, for enhanced productivity.

In some embodiments, the first material may be switched with the second material.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. All embodiments and examples disclosed herein are non-limiting embodiments and non-limiting examples.

What is claimed is:

1. A method of manufacturing a hybrid tray, comprising:
(1) providing a partial tray, made of a first material, having a cruciform shape and four recessed corners;
(2) providing four, rounded corner inserts, made of a second material; and
(3) attaching each respective one of the four, rounded corner inserts to each respective one of the four recessed corners of the partial tray, thereby making a hybrid tray with four, attached rounded corners; and
wherein the first material is different than the second material.

2. The method of claim 1, wherein the first material comprises a metal, a steel alloy, a magnesium alloy, a titanium alloy, or an aluminum alloy, and/or combinations thereof.

3. The method of claim 1, wherein the second material comprises a polymeric material, a polymer/fiber composite material, a thermoplastic polymer/fiber composite material, or a thermoset polymer/fiber composite material, and/or combinations thereof.

4. The method of claim 1, wherein attaching each respective one of the four rounded corner inserts to each respective one of the four recessed corners of the partial tray comprises:
(4) providing four overlapping first bond surfaces of each respective one of the four rounded corner inserts;
(5) providing four overlapping second bond surfaces at each respective one of the four recessed corners of the partial tray;
(6) aligning and overlapping each respective one of the four first overlapping bond surfaces with each respective one of the four overlapping second bond surfaces; and then
(7) forming four overlapping bond joints by attaching each respective one of the four overlapping first bond surfaces to each respective one of the four overlapping second bond surfaces.

5. The method of claim 4, further comprising fabricating one or more mechanical interlocking features at each respective one of the four overlapping bond joints, thereby improving bond strength.

6. The method of claim 1, further comprising:
(4) providing four non-conductive interlayers;
(5) placing each respective one of the four non-conductive interlayers between: (a) each respective one of the four overlapping first bond surfaces of each respective one of the four rounded corner inserts, and (b) each respective one of the four overlapping second bond surfaces at each respective one of the four recessed corners of the partial tray; and
wherein each respective one of the four non-conductive interlayers is configured to reduce galvanic corrosion between overlapping first and second bond surfaces.

7. The method of claim 1, further comprising:
(4) providing an upper molding tool and a lower molding tool;
(5) placing a removable gasket in-between the upper molding tool and the lower molding tool; and
(6) controlling and reducing flow of injected liquid resin with the removable gasket when attaching each respective one of the four rounded corner inserts to the partial tray with a Resin Transfer Molding (RTM) process.

8. The method of claim 4, further comprising laser-ablating and/or plasma-treating each respective one of the four overlapping second bond surfaces of the partial tray before attaching each respective one of the four rounded corner inserts to the partial tray.

9. The method of claim 1, further comprising:
(a) cutting a rectangular metal sheet into a cruciform-shaped sheet, and then removing four cutout corners from the rectangular metal sheet;
(b) cutting out four, fibrous preform corner inserts from one or more sheets of a fibrous material;
(c) providing a press and a molding tool with four rounded corners;
(d) draping each respective one of the four, fibrous preform corner inserts onto each respective one of the four rounded corners of the molding tool;
(e) press-forming the four, fibrous preform corner inserts on the four rounded corners of the molding tool to make four, rounded fibrous preform corner inserts;
(f) placing the cruciform-shaped sheet onto the molding tool, thereby making an assembly comprising the cruciform-shaped sheet and the four, rounded fibrous preform corner inserts; then
(g) using a Resin Transfer Molding (RTM) process to inject thermoset resin around each respective one of the four, rounded fibrous preform corner inserts and the cruciform-shaped sheet; and then
(h) compressing and curing the assembly in the press.

10. The method of claim 1, further comprising:
(a) cutting a rectangular metal sheet into a cruciform-shaped sheet, and then removing four cutout corners from the rectangular metal sheet;
(b) providing a press and a molding tool having four rounded corners;
(c) press-forming the cruciform-shaped sheet into a preformed partial tray using the molding tool;
(d) cutting out four, fibrous preform corner inserts from one or more sheets of a fibrous material;
(e) draping each respective one of the four, fibrous preform corner inserts on each respective one of the four rounded corners of the molding tool;
(f) placing the preformed partial tray onto the molding tool, thereby making an assembly comprising the preformed partial tray and the four, fibrous preform corner inserts; then
(g) using a Resin Transfer Molding (RTM) process to inject thermoset resin around each respective one of the four, fibrous preform corner inserts and the preformed partial tray; and then
(h) compressing and curing the assembly in the press.

11. The method of claim 1, further comprising:
(a) cutting a rectangular metal sheet into a cruciform-shaped sheet, and then removing four cutout corners from the rectangular metal sheet;
(b) providing a press and a molding tool having four rounded corners;
(c) press-forming the cruciform-shaped sheet into a preformed partial tray using the molding tool;
(d) cutting out four, fibrous preform corner inserts from one or more sheets of a fibrous material;
(e) draping each respective one of the four, fibrous preform corner inserts onto each respective one of the four rounded corners of the molding tool;
(f) press-forming the four, fibrous preform corner inserts on the molding tool, thereby making four, rounded fibrous preform corner inserts; then
(g) placing the preformed partial tray onto the molding tool, thereby making an assembly comprising the four, rounded fibrous preform corner inserts and the preformed partial tray; then:
(h) using a Resin Transfer Molding (RTM) process to inject thermoset resin around each respective one of the four, rounded fibrous preform corner inserts and the preformed partial tray; and then
(i) compressing and curing the assembly in the press.

12. A method of manufacturing a hybrid metal/composite tray for use in a vehicle, comprising:
(1) providing a partial tray, made of a metal, having a cruciform-shape and four recessed corners;
(2) providing four rounded corner inserts, made of a polymer/fiber composite material; then
(3) attaching each respective one of the four rounded corner inserts to each respective one of the four recessed corners of the partial tray, thereby making a hybrid tray with four attached rounded corners;
wherein the hybrid metal/composite tray is configured to be attached to a vehicle; and
wherein the hybrid metal/composite tray is configured to hold one or more batteries.

13. The method of claim 1, further comprising:
(a) cutting a rectangular metal sheet into a cruciform-shaped sheet, and then removing four cutout corners from the rectangular metal sheet;
(b) cutting out four, thermoplastic polymer/fiber composite prepreg corner inserts from one or more sheets of a thermoplastic polymer/fiber composite prepreg material;
(c) providing a press and a molding tool with four rounded corners;
(d) placing each respective one of the four, thermoplastic polymer/fiber composite prepreg corner inserts onto each respective one of the four rounded corners of the molding tool;
(e) press-forming the four, thermoplastic polymer/fiber composite prepreg corner inserts on the four rounded corners of the molding tool to make four, rounded thermoplastic polymer/fiber composite prepreg corner inserts;
(f) placing the cruciform-shaped sheet onto the molding tool, thereby making an assembly comprising the cruciform-shaped sheet and the four, rounded thermoplastic polymer/fiber composite prepreg corner inserts; then
(g) compressing the assembly using the press to make a compressed assembly; and then
(h) curing the compressed assembly at an elevated temperature.

14. The method of claim 1, further comprising:
(a) cutting a rectangular metal sheet into a cruciform-shaped sheet, and then removing four cutout corners from the rectangular metal sheet;
(b) providing a press and a molding tool having four rounded corners;
(c) press-forming the cruciform-shaped sheet into a preformed partial tray using the molding tool;
(d) cutting out four, thermoplastic polymer/fiber composite prepreg corner inserts from one or more sheets of a thermoplastic polymer/fiber composite prepreg material;
(e) placing each respective one of the four, thermoplastic polymer/fiber composite prepreg corner inserts on each respective one of the four rounded corners of the molding tool;
(f) placing the preformed partial tray onto the molding tool, thereby making an assembly comprising the preformed partial tray and the four, thermoplastic polymer/fiber composite prepreg corner inserts; then
(g) compressing the assembly using the press to make a compressed assembly; and then
(h) curing the compressed assembly at an elevated temperature.

15. The method of claim 1, further comprising:
(a) cutting a rectangular metal sheet into a cruciform-shaped sheet, and then removing four cutout corners from the rectangular metal sheet;
(b) providing a press and a molding tool having four rounded corners;
(c) press-forming the cruciform-shaped sheet into a preformed partial tray using the molding tool;
(d) cutting out four, thermoplastic polymer/fiber composite prepreg corner inserts from one or more sheets of a thermoplastic polymer/fiber composite prepreg material;
(e) placing each respective one of the four, thermoplastic polymer/fiber composite prepreg corner inserts onto each respective one of the four rounded corners of the molding tool;
(f) press-forming the four, thermoplastic polymer/fiber composite prepreg corner inserts on the molding tool, thereby making four, rounded thermoplastic polymer/fiber composite prepreg corner inserts; then
(g) placing the preformed partial tray onto the molding tool, thereby making an assembly comprising the four, rounded thermoplastic polymer/fiber composite prepreg corner inserts and the preformed partial tray; then
(h) compressing the assembly using the press to make a compressed assembly; and then
(i) curing the compressed assembly at an elevated temperature.

16. The method of claim 3, wherein the second material further comprises glass fibers, carbon fibers, graphite fibers, metal fibers, ceramic fibers, polymer fibers, or natural fibers, and/or combinations thereof.

17. The method of claim 1,
wherein the first material comprises a metal, a steel alloy, a magnesium alloy, a titanium alloy, or an aluminum alloy, and/or combinations thereof; and
wherein the second material comprises a polymeric material, a polymer/fiber composite material, a thermoplastic polymer/fiber composite material, or a thermoset polymer/fiber composite material, and/or combinations thereof.

18. The method of claim 17, wherein the second material further comprises glass fibers, carbon fibers, graphite fibers, metal fibers, ceramic fibers, polymer fibers, or natural fibers, and/or combinations thereof.

19. A method of manufacturing a hybrid metal/composite tray, comprising:
(1) cutting a rectangular metal sheet into a cruciform-shaped metal sheet, and then removing four cutout corners from the rectangular metal sheet to make a cruciform-shaped metal sheet with four recessed corners;
(2) cutting out four, thermoplastic polymer/fiber composite prepreg corner inserts from one or more sheets of a thermoplastic polymer/fiber composite prepreg material;
(3) providing a press and a molding tool with four rounded corners;
(4) placing each respective one of the four, thermoplastic polymer/fiber composite prepreg corner inserts onto each respective one of the four rounded corners of the molding tool;
(5) press-forming the four, thermoplastic polymer/fiber composite prepreg corner inserts on the molding tool to make four, rounded thermoplastic polymer/fiber composite prepreg corner inserts;
(6) placing the cruciform-shaped metal sheet onto the molding tool, thereby making an assembly comprising the cruciform-shaped metal sheet and the four, rounded thermoplastic polymer/fiber composite prepreg corner inserts; then
(7) compressing the assembly using the press to make a compressed assembly; and then
(8) curing the compressed assembly at an elevated temperature, thereby making a hybrid metal/composite tray.

20. The method of claim 19,
wherein the hybrid metal/composite tray is configured to be attached to a vehicle;
wherein the hybrid metal/composite tray is configured to hold one or more batteries; and
wherein the cruciform-shaped metal sheet comprises a steel alloy or an aluminum alloy.
